(19) United States
(12) Patent Application Publication
(10) Pub. No.: US 2025/0220072 A1
(43) Pub. Date: Jul. 3, 2025

(54) RESOURCE ALLOCATION METHOD AND RELATED APPARATUS

(71) Applicant: TENCENT TECHNOLOGY (SHENZHEN) COMPANY LIMITED, Shenzhen (CN)

(72) Inventor: Bo WU, Shenzhen (CN)

(73) Assignee: TENCENT TECHNOLOGY (SHENZHEN) COMPANY LIMITED, Shenzhen (CN)

(21) Appl. No.: 19/083,742

(22) Filed: Mar. 19, 2025

Related U.S. Application Data
(63) Continuation of application No. PCT/CN2023/131414, filed on Nov. 14, 2023.

(30) Foreign Application Priority Data
Mar. 14, 2023 (CN) 202310291706.7

(51) Int. Cl. H04L 67/1008; H04L 67/1012

(52) U.S. Cl. CPC H04L 67/1008; H04L 67/1012

(57) ABSTRACT

An apparatus, computer-readable memory storing a program, and method for resource allocation, including receiving a traffic flow request packet from a first terminal, the packet comprising one or more pieces of historical content traffic flow consumption time length information; determining a content traffic flow consumption time length feature of the first terminal based on the one or more pieces of historical content traffic flow consumption time length information; obtaining a load quantity of one or more servers based on the content traffic flow consumption time length feature meeting a historical content traffic flow consumption time length condition, each second terminal having a content traffic flow consumption time length greater than a first traffic flow time length threshold; determining a server with the least load quantity among the one or more servers as a first server; and transmitting the traffic flow request packet to the first server.

### CROSS-REFERENCE TO RELATED APPLICATIONS

This application is a continuation application of International Application No. PCT/CN2023/131414 filed on Nov. 14, 2023 which claims priority to Chinese Patent Application No. 202310291706.7, filed with the China National Intellectual Property Administration on Mar. 14, 2023, the disclosures of each being incorporated by reference herein in their entireties.

### FIELD

The disclosure relates to the field of cloud computing technologies, and to resource allocation technologies.

### BACKGROUND

In the related art, with the continuous development of audio/video information technologies, an audio/video service comes in more forms, such as a short video service, a network livestreaming service, an audio/video on-demand service, and an audio/video call, and enriches life of users while bringing visual experience to a large quantity of users. The audio/video service may be implemented by depending on a network transmission service. Therefore, a transmission process of audio/video data is crucial.

When the user selects audio/video watching, a user terminal (which may be referred to as a terminal) may transmit a traffic flow request packet to a load balancer. The load balancer may evenly map the request of the user to servers in different content delivery network (CDN) clusters by using a round robin method or a random method. However, if a plurality of users simultaneously occupy a server for a long period of time, load of the server may be higher than that of other servers. Servers are not evenly allocated due to long-term occupation of resources, and a problem such as service interruption may be caused for the server with excessively high load.

### SUMMARY

Provided are a resource allocation method and apparatus, a device, a storage medium, and a program product, which optimize traffic flow distribution by dynamically assessing historical content consumption time lengths and server load conditions. These embodiments enhance system efficiency by reducing server congestion, improving resource utilization, and optimizing traffic allocation across multiple servers.

Some embodiments provide a resource allocation method, performed by a computer device, the method comprising: receiving a traffic flow request packet transmitted by a first terminal, the traffic flow request packet comprising one or more pieces of historical content traffic flow consumption time length information; determining a content traffic flow consumption time length feature of the first terminal based on the one or more pieces of historical content traffic flow consumption time length information; obtaining a load quantity of one or more servers based on the content traffic flow consumption time length feature meeting a historical content traffic flow consumption time length condition, wherein the load quantity of each server is determined based on a number of second terminals accessing each server, each second terminal has a content traffic flow consumption time length greater than a first traffic flow time length threshold; determining a server with a least load quantity among the one or more servers as a first server; and transmitting the traffic flow request packet to the first server.

Some embodiments provide a resource allocation apparatus, comprising: at least one memory configured to store program code; and at least one processor configured to read the program code and operate as instructed by the program code, the program code comprising: receiving code configured to cause at least one of the at least one processor to a traffic flow request packet transmitted by a first terminal, the traffic flow request packet comprising one or more pieces of historical content traffic flow consumption time length information; determining code configured to cause at least one of the at least one processor to determine a content traffic flow consumption time length feature of the first terminal based on the one or more pieces of historical content traffic flow consumption time length information; obtaining code configured to cause at least one of the at least one processor to obtain a load quantity of one or more servers based on the content traffic flow consumption time length feature meeting a historical content traffic flow consumption time length condition, wherein the load quantity of each server is determined based on a number of second terminals accessing each server, each second terminal has a content traffic flow consumption time length greater than a first traffic flow time length threshold; wherein the determining code is further configured to cause at least one of the at least one processor to determine a server with a least load quantity among the one or more servers as a first server; and transmission code configured to cause at least one of the at least one processor to transmit the traffic flow request packet to the first server.

Some embodiments provide a non-transitory computer-readable storage medium storing computer code which, when executed by at least one processor, causes the at least one processor to at least: receive a traffic flow request packet transmitted by a first terminal, the traffic flow request packet comprising one or more pieces of historical content traffic flow consumption time length information; determine a content traffic flow consumption time length feature of the first terminal based on the one or more pieces of historical content traffic flow consumption time length information; obtaining a load quantity of one or more servers based on the content traffic flow consumption time length feature meeting a historical content traffic flow consumption time length condition, wherein the load quantity of each server is determined based on a number of second terminals accessing each server, each second terminal has a content traffic flow consumption time length greater than a first traffic flow time length threshold; determine a server with a least load quantity among the one or more servers as a first server; and transmit the traffic flow request packet to the first server.

### BRIEF DESCRIPTION OF THE DRAWINGS

To describe the technical solutions of some embodiments of this disclosure more clearly, the following briefly introduces the accompanying drawings for describing some embodiments. The accompanying drawings in the following description show only some embodiments of the disclosure, and a person of ordinary skill in the art may still derive other drawings from these accompanying drawings without creative efforts. In addition, one of ordinary skill would understand that aspects of some embodiments may be combined together or implemented alone.

FIG. 1 is a schematic diagram of CDN server load balancing according to some embodiments.

FIG. 2 is a schematic diagram of server load differentiation according to some embodiments.

FIG. 3 is a schematic diagram of a resource allocation system according to some embodiments.

FIG. 4 is a flowchart of a resource allocation method according to some embodiments.

FIG. 5 is a flowchart of a resource allocation method according to some embodiments.

FIG. 6 is a flowchart of a resource allocation method according to some embodiments.

FIG. 7 is a schematic diagram of storing a resource with high and low definition in the same server according to some embodiments.

FIG. 8 is a schematic diagram of storing resources with high and low definition in different servers according to some embodiments.

FIG. 9 is a flowchart of a resource allocation method according to some embodiments.

FIG. 10 is a flowchart of a resource allocation method according to some embodiments.

FIG. 11 is a flowchart of a resource allocation method according to some embodiments.

FIG. 12 is a flowchart of a resource allocation method according to some embodiments.

FIG. 13 is a flowchart of a resource allocation method according to some embodiments.

FIG. 14 is a flowchart of a resource allocation method according to some embodiments.

FIG. 15 is a flowchart of a resource allocation method according to some embodiments.

FIG. 16 is a flowchart of a resource allocation method according to some embodiments.

FIG. 17 is a flowchart of a resource allocation method according to still some embodiments.

FIG. 18 is a schematic diagram of data transmission between a server and a load balancer according to some embodiments.

FIG. 19 is a schematic diagram of a structure of a resource allocation apparatus according to some embodiments.

FIG. 20 is a schematic diagram of a structure of a resource allocation apparatus according to some embodiments.

FIG. 21 is a schematic diagram of a structure of a resource allocation apparatus according to some embodiments.

FIG. 22 is a schematic diagram of a structure of a server according to some embodiments.

### DESCRIPTION OF EMBODIMENTS

To make the objectives, technical solutions, and advantages of the present disclosure clearer, the following further describes the present disclosure in detail with reference to the accompanying drawings. The described embodiments are not to be construed as a limitation to the present disclosure. All other embodiments obtained by a person of ordinary skill in the art without creative efforts shall fall within the protection scope of the present disclosure.

In the following descriptions, related “some embodiments” describe a subset of all possible embodiments. However, it may be understood that the “some embodiments” may be the same subset or different subsets of all the possible embodiments, and may be combined with each other without conflict. As used herein, each of such phrases as “A or B,” “at least one of A and B,” “at least one of A or B,” “A, B, or C,” “at least one of A, B, and C,” and “at least one of A, B, or C,” may include all possible combinations of the items enumerated together in a corresponding one of the phrases. For example, the phrase “at least one of A, B, and C” includes within its scope “only A”, “only B”, “only C”, “A and B”, “B and C”, “A and C” and “all of A, B, and C.”

Some embodiments provides a resource allocation method. Terminals with long content traffic flow consumption time lengths are distributed across different servers, to avoid service interruption caused by excessively high server load due to a plurality of terminals with long content traffic flow consumption time lengths being concentrated in some servers, and improve continuity and robustness of the servers.

The terms such as “first”, “second”, “third”, and “fourth” (if any) are used for distinguishing similar objects and not necessarily used for describing any particular order or sequence. Data used in this way is exchangeable where appropriate, so that some embodiments described herein can be implemented in an order different from the order shown or described herein. In addition, the terms “include”, “corresponding to”, and any other variants are intended to cover the non-exclusive inclusion. For example, a process, method, system, product, or device that includes a series of operations or units is not necessarily limited to those expressly listed operations or units, but may include other operations or units not expressly listed or inherent to such a process, method, product, or device. For ease of understanding of the technical solutions provided in some embodiments, some key terms used some embodiments are explained below first.

A transmission control protocol (TCP) is a connection-oriented and reliable transport layer communication protocol based on a bytestream.

Quick UDP Internet connection (QUIC) is a UDP-based low-delay Internet transport layer protocol.

Quality of experience (QoE) refers to a subjective feeling of a user about quality and performance of a device, a network, a system, an application, or a service. The QoE refers to how difficult the user feels to complete an entire process.

Quality of service (QoS) refers to a capability of a network to use various technologies to provide a better service for specified network communication, is a security mechanism of the network, and is a technology used to resolve problems such as network latency and congestion. The QoS is very important for a network with a limited capacity, and especially for a streaming multimedia application, for example, based on voice over Internet protocol (VoIP) and Internet protocol television (IPTV). These applications usually need a constant transmission rate, and are affected by a delay.

Round-trip time (RTT) is an important performance indicator in a computer network, and indicates total time from a moment at which a transmit end transmits data to a moment at which the transmit end receives acknowledgment from a receive end (where the receive end immediately transmits the acknowledgment after receiving the data).

An Internet protocol (IP) is a network layer protocol in a TCP/IP system. An objective of designing the IP is to improve network scalability. First, Internet problems are resolved, and interworking between large-scale and heterogeneous networks is implemented. Second, a coupling relationship between a top-layer network application and a bottom-layer network technology is partitioned, to facilitate independent development of the top-layer network application and the bottom-layer network technology. According to an end-to-end design principle, the IP provides only a connectionless, unreliable, best-effort packet transmission service for a host.

A distributed denial-of-service (DDoS) attack may cause a plurality of computers to be attacked at same time. As a result, an attacked target cannot be normally used.

Load balancing is an important means of balancing load of devices in a CDN cluster, avoiding degradation of traffic flow transmission performance caused by an excessively high head of a single device and even service interruption caused by device breakdown. In the related art, in the CDN cluster, when a user terminal transmits a traffic flow request packet, a function of a load balancer is to “evenly” map these connection requests to different CDN servers, so that excessively high load caused when a single server responds to a traffic flow request and even service interruption caused by device breakdown are avoided. The load balancer is an important manner for improving system robustness and ensuring service continuity.

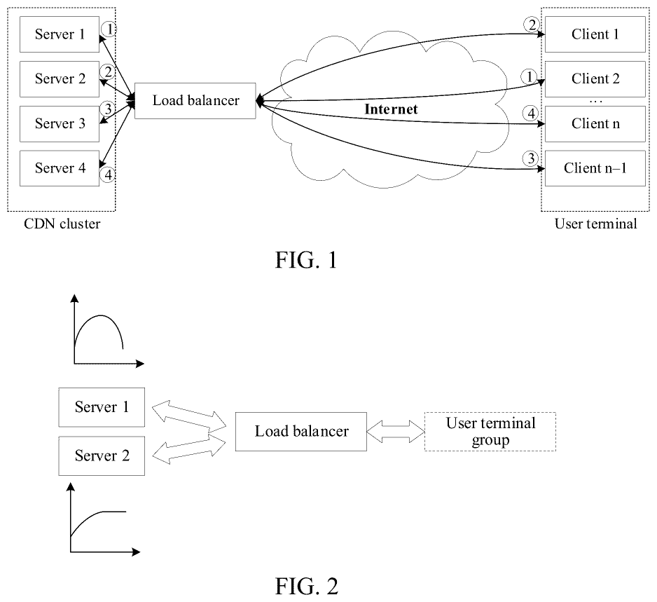

As shown in FIG. 1, the CDN cluster receives traffic flow obtaining requests from a plurality of user terminals, and before officially responding to traffic flows, the load balancer selects different CDN servers (to provide a traffic flow transmission service) for each connection request. Specifically, the load balancer respectively selects a server 2, a server 1, a server 4, and a server 3 for connections of a client 1, a client 2, a client n, and a client n-1 to create connections and subsequent traffic flow transmission. In this way, servers in each CDN cluster may provide a service for only a few (rather than all) user terminals, because even if there are a plurality of concurrent traffic flows, each CDN server does not cause service interruption due to excessively high load. The load balancer is also an important means for defending against various DDoS attacks. To be specific, the load balancer may perform traffic flow “distribution” on attacks from different clients, to avoid device failure caused by excessively high load of a server.

The load balancer may be a single device, or may integrate a load balancing function in an existing device (such as a gateway). A load balancing algorithm may be classified into the following types.

(1) Round robin method: Connections are “mapped” to different servers in sequence according to an order of the connections. As shown in FIG. 1, the load balancer receives connection requests from the client 2, the client 1, the client n, and the client n-1 in sequence, and maps the four requests to the server 1, the server 2, the server 3, and the server 4 in sequence in a round robin manner.

(2) Random method: For connection requests of different clients, a load balancer “randomly” selects a server from a CDN cluster to respond to a connection request of a user terminal. As shown in FIG. 1, for connection requests of the client 1, the client 2, the client n-1, and the client n, the load balancer respectively and randomly selects the server 2, the server 1, the server 4, and the server 3 to respond to the requests of the client.

(3) Hash method: After receiving connection requests from different user terminals, a load balancer performs a hash operation based on client information, and selects a corresponding CDN server based on a hash result. For example, an address of a client is src, and a source port is sport. When the load balancer receives a connection request from the client, an ID number (Server_ID) of the server may be obtained through calculation of formula (1):

$$Server\_ID = Hash ( src ‖ sport ) . \qquad ( 1 )$$

The symbol “∥” represents a concatenation operation.

Differences in connection time lengths, overheads, and the like caused by behavior habits of users are not fully considered in a load balancing algorithm provided in the related art. Consequently, load balancing between servers cannot be well implemented by using the load balancing algorithm. For example, if a user of a terminal is more inclined to watch specific (some) video livestreaming for a long period of time, and video watching time of the user is long (for example, frequent switching of livestreaming content rarely occurs), in this process, duration of a connection between a user terminal and a server is long, in other words, the connection occupies a resource of a server for a long period of time. If a plurality of connections occupy a resource of a server at the same time for a long time, in the long time, load of the server is increasingly large compared with other servers. The foregoing problems are caused because of the following reasons: When a load balancer provided in the related art performs a load balancing operation at a start stage of a connection, behavior habits of a user of a terminal corresponding to the connection, traffic flow use habits of the user, cannot be fully considered, easily causing long-term occupation of resources.

As shown in FIG. 2, after receiving connection requests from a plurality of user terminals (where the plurality of user terminals form a user terminal group), a load balancer allocates these requests to a server 1 and a server 2 by using a method provided in the related art. However, because the behavior habits of the users are not considered in the foregoing load balancing process, the following results may be caused: Duration of a flow allocated to the server 2 is long, and duration of a flow allocated to the server 1 is short. Therefore, load of the server 1 becomes very small after a short period of time. The server 2 maintains high load for a long period of time (for example, a terminal user of these flows watches livestreaming for a long period of time, which consumes a resource of the server 2 for a long period of time). When a new connection request arrives, the load balancer selects a corresponding server again based on the round robin method, the hash method, the random method, and the like. In this case, when load of the server 2 is very high originally, the load may become higher as the new connection request arrives, and even a problem such as service interruption is caused.

In some embodiments, to resolve the problem that different content traffic flow consumption time lengths differ in occupation of load of a server, a resource allocation method based on load balancing of an audio/video watching behavior habit of a user is provided. When a connection is established, a cloud server (a data transmit end) selects an appropriate server based on a historical session time length of a user terminal and a current load condition of the server to respond to a user request, so as to avoid a potential security risk, such as service interruption caused by a plurality of long-term traffic flows occupying load of a server for a long period of time that may be caused by the method provided in the related art. Compared with an indiscriminate load balancing method in the related art in which an audio/video watching behavior habit of a user is not considered, in the method provided in some embodiments, historical information of the terminal user can be fully considered, and sessions of the terminal user who is inclined to watch for a long period of time are evenly distributed across servers, so that excessively high load of a server caused by a plurality of long-term traffic flows “clustering” on the server is avoided, and improvement of continuity and robustness of a service capability of a CDN manufacturer is facilitated.

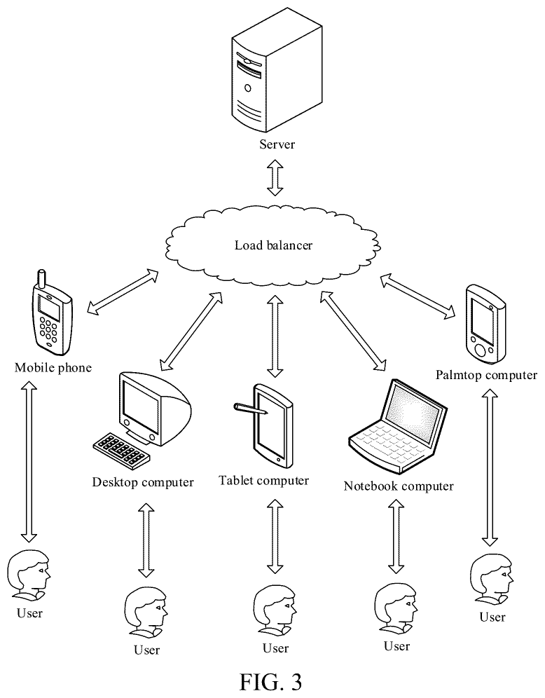

For ease of understanding, FIG. 3 is a diagram of an application environment of a resource allocation method according to some embodiments. As shown in FIG. 3, the resource allocation method in some embodiments is applied to a resource allocation system. The resource allocation system includes a server, a load balancer, and a user terminal. The server may be an independent physical server, or may be a server cluster or a distributed system including a plurality of physical servers, or may be a cloud server that provides cloud computing services such as a cloud service, a cloud database, cloud computing, a cloud function, cloud storage, a network service, cloud communication, a middleware service, a domain name service, a security service, a content delivery network (CDN), and a big data and artificial intelligence (AI) platform. The terminal may be a smartphone, a tablet computer, a notebook computer, a desktop computer, a smart speaker, a smartwatch, or the like, but is not limited thereto. The terminal and the server may be directly or indirectly connected in a wired or wireless communication manner. This is not limited herein.

The load balancer first receives a traffic flow request packet transmitted by a first terminal. The traffic flow request packet carries N pieces of historical content traffic flow consumption time length information, and N is an integer greater than 1. Second, the load balancer determines a content traffic flow consumption time length feature of the first terminal based on the N pieces of historical content traffic flow consumption time length information. Next, if the content traffic flow consumption time length feature satisfies a historical content traffic flow consumption time length condition, the load balancer obtains a load quantity of each of K servers. The load quantity of the server is a quantity of second terminals accessing to the server. The second terminal is a terminal of which a traffic flow consumption time length accessed by the server is greater than a first traffic flow time length threshold. K is an integer greater than 1. Then, the load balancer determines a server with a smallest load quantity in the K servers as a first server. Finally, the load balancer transmits, to the first server, the traffic flow request packet transmitted by the first terminal.

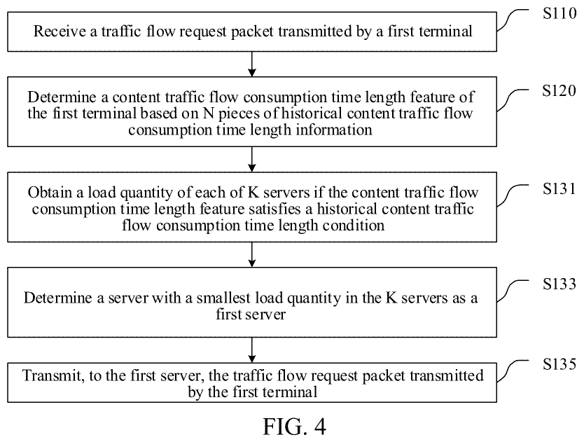

The following describes a resource allocation method from the perspective of the load balancer. Refer to FIG. 4. The resource allocation method according to some embodiments includes S110 to S135 described below specifically.

S110: Receive a traffic flow request packet transmitted by a first terminal.

The first terminal may be a terminal corresponding to any user. When the user selects content on the first terminal for playing back, the first terminal may transmit the traffic flow request packet. In some embodiments, the content may be audio, a video, or the like. This is not limited herein.

The traffic flow request packet may be a packet configured for requesting to provide traffic flows consumed by corresponding content for the user. The traffic flow request packet carries N pieces of historical content traffic flow consumption time length information. N is an integer greater than 1. Historical content may be content already played back for the user before the traffic flow request packet is transmitted this time. The historical content traffic flow consumption time length information may be information configured for reflecting a time length of traffic flows consumed for playing back the historical content. The N pieces of historical content traffic flow consumption time length information may be N pieces of information configured for reflecting a time length of traffic flows consumed for playing back the historical content. The historical content traffic flow consumption time length information may include historical content traffic flow consumption time length data. The historical content traffic flow consumption time length data may be a specific value of a traffic flow consumption time length for playing back the historical content, for example, may be 15 min or 30 min.

In some cases, content with a long-term traffic flow is generally played back on a long content platform, and content with a short-term traffic flow is generally played back on a short content platform. For example, a long video is played back on various long video platforms, and a short video is played back on various short video platforms. To be specific, a playback platform of the historical content may roughly reflect, to some extent, a time length of traffic flows consumed by the user for playing back the historical content. Therefore, the historical content traffic flow consumption time length information may include playback platform information of the historical content.

In some embodiments, the historical content traffic flow consumption time length information may be obtained by encrypting the historical content traffic flow consumption time length data. When the first terminal starts an audio/video application, the first terminal may transmit a traffic flow request packet. The traffic flow request packet carries N pieces of historical content traffic flow consumption time length information. The historical content traffic flow consumption time length information may be information obtained through encryption of historical content traffic flow consumption time length data consumed by historical content that a user recently watches through the first terminal. The historical content traffic flow consumption time length information is stored in the first terminal. The load balancer receives the traffic flow request packet transmitted by the first terminal.

S120: Determine a content traffic flow consumption time length feature of the first terminal based on the N pieces of historical content traffic flow consumption time length information.

To resolve a technical problem existing in the related art, in some embodiments, a behavior habit of a user may be considered, for example, a traffic flow use habit of the user, so that load balancing can be performed based on the traffic flow use habit. Therefore, the load balancer may determine the content traffic flow consumption time length feature of the first terminal based on the N pieces of historical content traffic flow consumption time length information. The content traffic flow consumption time length feature may reflect a traffic flow use habit of a user corresponding to the first terminal, and then whether the user is a user who uses traffic flows for a long period of time is determined based on the content traffic flow consumption time length feature.

In some embodiments, the historical content traffic flow consumption time length information may include historical content traffic flow consumption time length data. Therefore, the N pieces of historical content traffic flow consumption time length data may be calculated in S120, to obtain the content traffic flow consumption time length feature.

Representation of the content traffic flow consumption time length feature is not limited in some embodiments, provided that the feature can represent a traffic flow use habit of the user. In some embodiments, the content traffic flow consumption time length feature may be represented by using a time length value. In this case, the content traffic flow consumption time length feature may be, for example, a content traffic flow consumption time length average value, a content traffic flow consumption time length variance value, or a content traffic flow consumption time length maximum value. In some cases, because the historical content traffic flow consumption time length information may include a playback platform identifier of the historical content, in another possible implementation, the content traffic flow consumption time length feature may be represented by using the playback platform information.

Representation of the content traffic flow consumption time length feature is different, and implementations of S120 are also different. For example, when the content traffic flow consumption time length feature is a content traffic flow consumption time length average value, the load balancer may calculate an average value of the historical content traffic flow consumption time length data included in the N pieces of historical content traffic flow consumption time length information, to obtain the content traffic flow consumption time length average value. For another example, when the content traffic flow consumption time length feature is a content traffic flow consumption time length maximum value, the load balancer may select a maximum value from the historical content traffic flow consumption time length data included in the N pieces of historical content traffic flow consumption time length information, to obtain the content traffic flow consumption time length maximum value.

When the historical content traffic flow consumption time length information is obtained by encrypting the historical content traffic flow consumption time length data, and the content traffic flow consumption time length feature is the content traffic flow consumption time length average value, an implementation of S120 may be that the load balancer first decrypts the N pieces of historical content traffic flow consumption time length information, to obtain N pieces of historical content traffic flow consumption time length data corresponding to the N pieces of historical content traffic flow consumption time length information. Then, an average value of the N pieces of historical content traffic flow consumption time length data is calculated to obtain the content traffic flow consumption time length feature.

S131: Obtain a load quantity of each of K servers if the content traffic flow consumption time length feature satisfies a historical content traffic flow consumption time length condition.

The load quantity of the server is a quantity of second terminals accessing to the server. The second terminal may be a terminal of which a traffic flow consumption time length accessed by the server is greater than a first traffic flow time length threshold. If the traffic flow consumption time length is greater than the first traffic flow time length threshold, a consumed traffic flow may be referred to as a long-term traffic flow. K is an integer greater than 1.

The historical content traffic flow consumption time length condition may be a condition that the user is a user who uses traffic flows for a long period of time. If the content traffic flow consumption time length feature satisfies the historical content traffic flow consumption time length condition, it indicates that the user of the first terminal is a user who uses traffic flows for a long period of time. Therefore, a load quantity of each of the K servers may be obtained, so as to select an appropriate server to provide a service with a long content traffic flow consumption time length.

In some embodiments, a historical content traffic flow consumption time length condition may be different depending on different content traffic flow consumption time length features. When the content traffic flow consumption time length feature is a time length value, the historical content traffic flow consumption time length condition may be a condition for defining a value range of the time length value. In some embodiments, defining the value range of the time length value means defining the time length value to be greater than a specific threshold. For example, if the content traffic flow consumption time length feature is a content traffic flow consumption time length average value, the historical content traffic flow consumption time length condition may be that the content traffic flow consumption time length average value is greater than the historical content traffic flow consumption time length threshold (for example, the specific threshold). When the content traffic flow consumption time length feature is the playback platform information, the historical content traffic flow consumption time length condition may be a condition for defining a playback platform. In some embodiments, defining the playback platform may mean defining the playback platform to be a long-content playback platform. For example, the historical content traffic flow consumption time length condition may be that a playback platform indicated by the playback platform information is a long-content playback platform.

If the content traffic flow consumption time length feature satisfies the historical content traffic flow consumption time length condition, it indicates that the behavior habit of the user for content (for example, a video) is watching a long video (for example, watching specific (some) video livestreaming for a long period of time), and video watching time is long (for example, frequent switching of livestreaming content rarely occurs), in this process, duration of a connection between a user terminal and a server is long, in other words, the connection occupies a resource of a server for a long period of time. The load balancer obtains a current load quantity of each of the K servers, to determine a quantity of second terminals that are of each server and that consume a long-term traffic flow currently, for example, determine a quantity of second terminals that already access to each server and that are used to watch long video.

S133: Determine a server with a smallest load quantity in the K servers as a first server.

The load balancer selects, from K load quantities corresponding to the K servers, a server with a smallest load quantity as the first server. In this case, a quantity of second terminals accessing to the first server is small, for example, a long-term traffic flow occupied by the first server is small.

S135: Transmit, to the first server, the traffic flow request packet transmitted by the first terminal.

The load balancer forwards, to the first server, the traffic flow request packet transmitted by the first terminal, to connect the terminal and the first server.

For example, the content traffic flow consumption time length feature is a content traffic flow consumption time length average value, and a CDN cluster includes a server A, a server B, a server C, and a server D. The server A, the server B, the server C, and the server D periodically transmit, to the load balancer, a load quantity packet generated based on a current load quantity. Specifically, a load quantity (a quantity of accessed second terminals consuming a long-term traffic flow) of the server A is 3; a load quantity (a quantity of accessed second terminals consuming a long-term traffic flow) of the server B is 4; a load quantity of the server C (a quantity of accessed second terminals consuming a long-term traffic flow) is 1; and a load quantity of the server D (a quantity of accessed second terminals consuming a long-term traffic flow) is 2. The user has watched audio/video (for example, historical content) for five times recently, and corresponding traffic flow consumption time lengths are respectively 15 min, 30 min, 29 min, 25 min, and 6 min. Traffic flow consumption time length data (for example, historical content traffic flow consumption time length data) of the five-time audio/video is encrypted to generate historical content traffic flow consumption time length information, and the information is stored in the first terminal. The user starts an audio/video application by using the first terminal, and the first terminal transmits, to the load balancer, a traffic flow request packet carrying five pieces of historical content traffic flow consumption time length information. The load balancer calculates a content traffic flow consumption time length average value of the first terminal after receiving the traffic flow request packet transmitted by the first terminal. The content traffic flow consumption time length average value of the first terminal is compared with the historical content traffic flow consumption time length threshold, to obtain that the content traffic flow consumption time length average value is greater than the historical content traffic flow consumption time length threshold. A load quantity of each of the four servers is obtained. A load quantity of the server C is the smallest. It is determined that the server C is the first server. The traffic flow request packet transmitted by the first terminal is forwarded to the first server, to connect the terminal and the server C.

Some embodiments provides a resource allocation method. The content traffic flow consumption time length feature corresponding to the N pieces of historical content traffic flow consumption time length information of the first terminal is compared with the historical content traffic flow consumption time length condition. If the content traffic flow consumption time length feature satisfies the historical content traffic flow consumption time length condition, a server with a smallest load quantity in the K servers is determined as the first server, and the traffic flow request packet of the first terminal is transmitted to the first server, to connect the first terminal and the first server. According to the method provided in some embodiments, terminals with long content traffic flow consumption time lengths are distributed across different servers, to avoid service interruption caused by excessively high server load due to a plurality of terminals with long content traffic flow consumption time lengths being concentrated in some servers, and improve continuity and robustness of the servers.

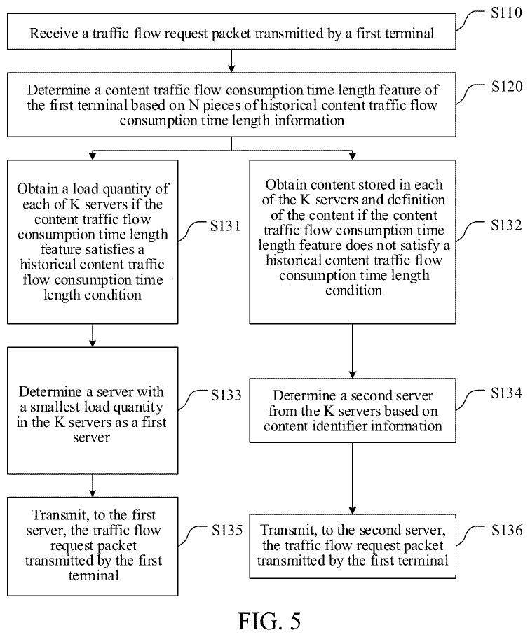

In an exemplary embodiment of the resource allocation method according to some embodiments corresponding to FIG. 4, reference is made to FIG. 5, the traffic flow request packet further carries content identifier information. The content identifier information is configured for indicating to-be-processed content that the user wants to watch and definition of the to-be-processed content. After S120, S132 to S136 are further included. S131 to S135 and S132 to S136 are parallel operations. During specific execution, S131 to S135 or S132 to S136 are selected to be performed according to a satisfied condition. The operations are described below specifically.

S132: Obtain content stored in each of the K servers and definition of the content if the content traffic flow consumption time length feature does not satisfy the historical content traffic flow consumption time length condition.

If the content traffic flow consumption time length feature does not satisfy the historical content traffic flow consumption time length condition, it indicates that the user is not a user who uses traffic flows for a long period of time, and is more likely a user who switches content frequently. For example, an audio/video behavior habit is switching videos frequently (for example, watching short videos), and watching time of each video is short (for example, short videos are frequently switched). In this process, duration of a session corresponding to each piece of content of the first terminal is short. In other words, the user is more inclined to pay more attention to whether audio/video is smooth. In some embodiments, smoothness may be reflected through definition of the content, and there is the following relationship between the smoothness and the definition: Higher definition indicates lower smoothness, and lower definition indicates higher smoothness. In a CDN server cluster, for the same content, content with different definition is usually stored in the same server or different servers after being encoded by an encoder.

The definition is clarity and an unambiguous degree of the content. When the content is a video, definition of the video depends on details and definition of edges of an image in the video. The definition of the video requires that an outline, texture, and details of an object may be clearly seen without blur or distortion. When the content is audio, definition of the audio requires that a tone, volume, and sound quality of sound can be clearly heard without noise or interference.

The definition of the content may be indicated by using a plurality of parameters, and the parameters may be different when the content is different. For a video, definition may be represented by using at least one of parameters such as a resolution, a data rate, a frame rate, sharpness, and contrast. A parameter for measuring the definition is not limited in some embodiments. The resolution indicates a quantity of pixels of an image or a video, and a common resolution is 720p (pixel), 1080p, 2K (2000 pixels), 4K, and the like. Generally, a higher resolution indicates higher definition. The bit rate may refer to a quantity of bits transmitted per second for a video. Generally, a higher data rate indicates higher definition of a video. The frame rate may refer to a quantity of picture frames played back per second. Generally, a higher frame rate indicates smoother playback of a video, for example, higher definition of the video. The sharpness may refer to edge definition of an image. Generally, higher sharpness indicates higher definition of a video. The contrast may refer to a degree of contrast between brightness and darkness of an image. Generally, higher contrast indicates higher definition of a video.

For audio, definition may be indicated by using at least one of parameters such as a signal to interference plus noise ratio and a bit rate. A parameter measuring the definition is not limited in some embodiments. The signal to interference plus noise ratio (SNR) may be a ratio of a voice signal to background noise. A higher signal to interference plus noise ratio indicates a clearer voice signal, for example, higher definition; otherwise, the higher signal to interference plus noise ratio indicates that a voice signal is greatly interfered with. The bit rate may refer to an amount of data per second in audio, indicates a compression degree and a data transmission rate of the audio, and is generally indicated by using kilobits per second (kbps) as a unit. Generally, a higher bit rate of audio indicates higher quality of the audio, for example, higher definition of the audio.

S134: Determine a second server from the K servers based on the content identifier information.

The second server is a server storing content that is the same as to-be-processed content indicated by the content identifier information and of which definition is lower than a definition threshold.

Because the content identifier information is configured for indicating content that the user wants to watch and definition of the corresponding content, the content stored in each of the K servers and the definition of the content may be compared with the content identifier information, to find that a server storing content that is the same as the to-be-processed content indicated by the content identifier information and of which definition is low is the second server.

S136: Transmit, to the second server, the traffic flow request packet transmitted by the first terminal.

The load balancer forwards, to the second server, the traffic flow request packet transmitted by the terminal, to connect the terminal and the second server.

For example, the content may be a video, and the CDN cluster includes a server A, a server B, a server C, and a server D. The server A, the server B, the server C, and the server D periodically transmit, to the load balancer, packets generated based on stored videos and definition of the videos. Specifically, the server A stores a video a with high definition, the server B stores a video a with low definition, the server C stores videos b with high definition and low definition, and the server D stores videos c with high definition and low definition. The user has watched audio/video for five times recently, and corresponding traffic flow consumption time lengths are respectively 2 min, 3 min, 5 min, 4 min, and 6 min. Traffic flow consumption time length data of the five-time audio/video is encrypted to generate historical video traffic flow consumption time length information, and the information is stored in the first terminal. The user starts an audio/video application by using the first terminal, and a video that the user wants to watch is the video a with low definition. The terminal transmits, to the load balancer, a traffic flow request packet carrying five pieces of historical video traffic flow consumption time length information and the content identifier information. The load balancer calculates a historical video traffic flow consumption time length average value of the first terminal after receiving the traffic flow request packet transmitted by the first terminal. The historical video traffic flow consumption time length average value of the first terminal is compared with the historical video traffic flow consumption time length threshold, to obtain that the historical video traffic flow consumption time length average value is less than the historical video traffic flow consumption time length threshold. Videos and definition of the videos stored in each of the four servers are obtained. The server B stores a video a with low definition. Therefore, it is determined that the server B is the second server. The traffic flow request packet transmitted by the terminal is forwarded to the second server, to connect the terminal and the server B.

Some embodiments provides a resource allocation method. The content traffic flow consumption time length feature corresponding to the N pieces of historical content traffic flow consumption time length information of the terminal is compared with the historical content traffic flow consumption time length condition. If the content traffic flow consumption time length feature satisfies the historical content traffic flow consumption time length condition, the first server with a smallest load quantity in the K servers is determined, and the traffic flow request packet of the first terminal is transmitted to the first server, to connect the first terminal and the first server. If the content traffic flow consumption time length feature does not satisfy the historical content traffic flow consumption time length condition, it is determined that the second server in the K servers stores to-be-processed content with low definition, and the traffic flow request packet of the first terminal is transmitted to the second server, to connect the first terminal and the second server. According to the method provided in some embodiments, terminals with long content traffic flow consumption time lengths are distributed across different servers, to avoid service interruption caused by excessively high server load due to a plurality of terminals with long content traffic flow consumption time lengths being concentrated in some servers. A server storing a video with low definition and high smoothness is selected for a user who frequently switches content, so that frame freezing caused by the user in a process of frequently switching videos is avoided. The server to which the terminal is connected is determined based on a behavior habit of the user, so that continuity and robustness of the server are improved.

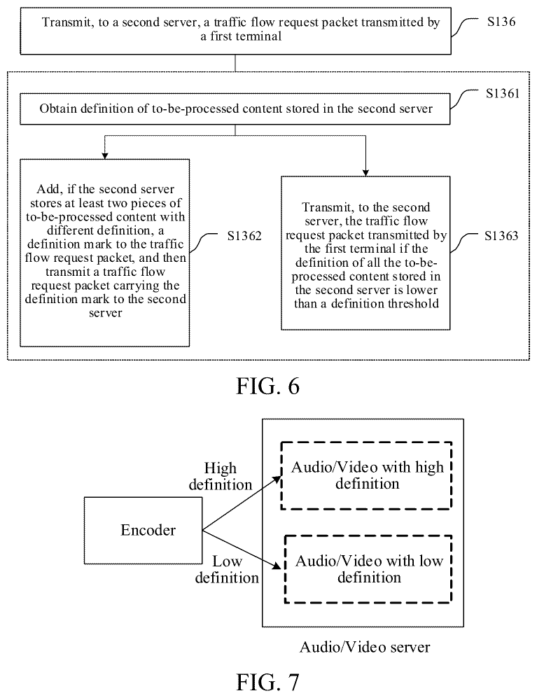

In an exemplary embodiment of the resource allocation method according to some embodiments corresponding to FIG. 5, reference is made to FIG. 6, S136 further includes S1361 to S1363. S1362 and S1363 are parallel operations. During specific execution, S1362 or S1363 is selected to be performed according to an execution condition. The operations are described below specifically.

S1361: Obtain definition of to-be-processed content stored in the second server.

Each server transmits a packet generated based on the stored content and the definition of the content to the load balancer. The second server stores to-be-processed content and definition of the to-be-processed content. Therefore, the load balancer may determine, based on the packet transmitted by the second server, the definition of the to-be-processed content stored in the second server.

S1362: Add, if the second server stores at least two pieces of to-be-processed content with different definition, a definition mark to the traffic flow request packet, and then transmit a traffic flow request packet carrying the definition mark to the second server.

The added definition mark is configured for indicating the second server to transmit to-be-processed content of which definition is lower than the definition threshold to the first terminal. The definition threshold is not limited in some embodiments, and may be set based on an actual requirement.

If the to-be-processed content stored in the second server includes content with high definition and content with low definition, a definition mark is added to the traffic flow request packet, and a marked traffic flow request packet is forwarded to the second server.

S1363: Transmit, to the second server, the traffic flow request packet transmitted by the first terminal if the definition of all the to-be-processed content stored in the second server is lower than the definition threshold.

If definition of all the to-be-processed content stored in the second server is low definition, the traffic flow request packet is directly forwarded to the second server.

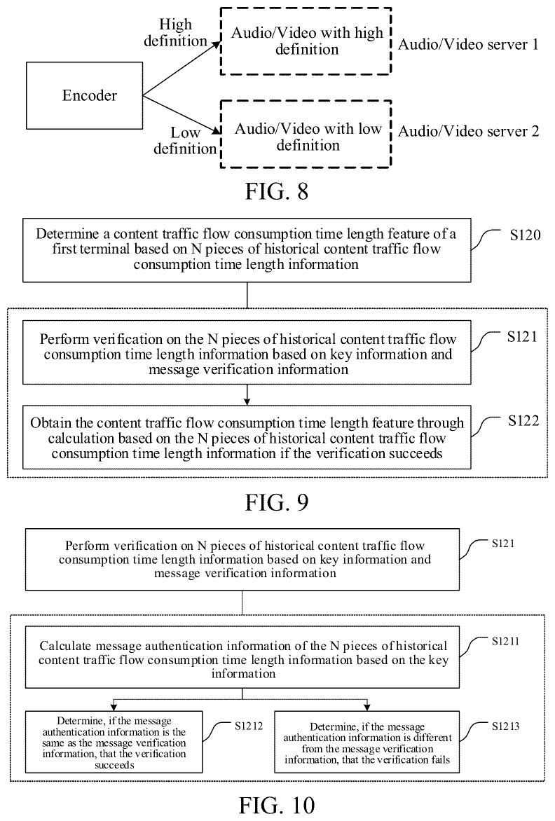

As shown in FIG. 7 and FIG. 8, an example in which content is audio/video is used. FIG. 7 is a schematic diagram of storing the same audio/video with two different types of definition in the same server according to some embodiments. FIG. 8 is a schematic diagram of storing the same audio/video with two different types of definition in different servers according to some embodiments. In a CDN server cluster, the same server may store audio/video with different definition, and the audio/video with different definition is usually stored in two manners: First, after the audio/video is encoded by an encoder, audio/video with high definition and audio/video with low definition in the same server are stored (as shown in FIG. 7). Second, after the audio/video is encoded by an encoder, audio/video with high definition and audio/video with low definition are respectively stored in different servers (as shown in FIG. 8). If a load balancer detects that an audio/video watching behavior habit of a user of a first terminal is to frequently switch watching content, the load balancer selects the audio/video with low definition (for example, smoothness) to respond to the traffic flow request packet. When the same audio/video with high definition and low definition is stored in the same server (as shown in FIG. 7), the load balancer forwards the traffic flow request packet from the first terminal to the server. The load balancer adds an audio/video definition identifier, denoted as Mark, to the traffic flow request packet. The identifier occupies 1 bit, and when a value is binary 1, it indicates that smooth (low-definition) audio/video is transmitted to the first terminal. When the same audio/video with high definition and low definition is stored in different servers (as shown in FIG. 8), the load balancer forwards the traffic flow request packet from the first terminal to a server (for example, the server 2) storing the audio/video with low definition.

Some embodiments provides a resource allocation method. A server storing a video with low definition and high smoothness is selected for a user who frequently switches to watch a video, so that frame freezing caused by the user in a process of frequently switching videos is avoided, and continuity and robustness of the server are improved.

In an exemplary embodiment of the resource allocation method according to some embodiments corresponding to FIG. 5, S132 further includes S1321 described below specifically.

S1321: Periodically obtain content stored in each of the K servers and definition of the content if the content traffic flow consumption time length feature does not satisfy the historical content traffic flow consumption time length condition.

Each of the K servers periodically transmits a packet generated based on the stored content and the definition of the content to the load balancer. The load balancer periodically obtains the content stored in each of the K servers and the definition of the content.

According to the resource allocation method provided in some embodiments, the content stored in each server and the definition of the content are periodically obtained, and a server storing a to-be-processed video with low definition is selected as a second server, so that frame freezing caused by the user in a process of frequently switching videos is avoided.

In an exemplary embodiment of the resource allocation method according to some embodiments corresponding to FIG. 4, reference is made to FIG. 9, the traffic flow request packet further includes key information and message verification information. S120 further includes S121 and S122 described below specifically.

S121: Perform verification on the N pieces of historical content traffic flow consumption time length information based on the key information and the message verification information.

The message verification information and the N pieces of historical content traffic flow consumption time length information are embedded in the traffic flow request packet, and the key information is embedded in the message verification information. The key information is information that may be used for encryption or decryption, and the message verification information is information configured for verifying that the N pieces of historical content traffic flow consumption time length information is not tampered with in a data transmission process. In some embodiments, the message verification information may be information in the form of a value. A form of the message verification information is not limited in some embodiments. In some cases, the message verification information may be information in the form of a letter, a symbol, or the like. Data included in the traffic flow request packet Pkt_history is as follows:

$$Pkt\_history = \{ MAC\_his , N , T\_session \_enc \_ 1 , … , T\_session \_enc \_N \} . \qquad ( 2 )$$

Pkt_history is a traffic flow request packet. MAC_his is message verification information of the traffic flow request packet Pkt_history. N is a quantity of pieces of historical content traffic flow consumption time length information. T_session_enc_1, . . . , and T_session_enc_N represent N pieces of historical content traffic flow consumption time length information.

$$MAC\_his = MAC \{ K\_share , N ‖ T\_session \_enc \_ 1 ‖ … ‖ T\_session \_enc \_N ) . \qquad ( 3 )$$

MAC_his is message verification information of the traffic flow request packet Pkt_history. K_share is key information. MAC{A, B} indicates that message verification information of data B is calculated by using a key A.

Verification is performed on the N pieces of historical content traffic flow consumption time length information in the traffic flow request packet based on the key information and the message verification information, to determine that the N pieces of historical content traffic flow consumption time length information are not tampered with in a data transmission process, which is described below specifically.

MAC_his (denoted as MAC_his_cpt_server) is calculated according to formula (3), and MAC_his calculated in the verification process may be referred to as message authentication information.

If MAC_his_cpt_server=MAC_his, it indicates that the verification succeeds, and the N pieces of historical content traffic flow consumption time length information are not tampered with in a data transmission process. If MAC_his_cpt_server≠MAC_his, it indicates that the verification fails, and the N pieces of historical content traffic flow consumption time length information are tampered with in a data transmission process.

S122: Obtain the content traffic flow consumption time length feature through calculation based on the N pieces of historical content traffic flow consumption time length information if the verification succeeds.

If the verification succeeds, and the content traffic flow consumption time length feature is a content traffic flow consumption time length average value, the N pieces of historical content traffic flow consumption time length information may be decrypted based on the key information to obtain N pieces of historical content traffic flow consumption time length data. An average value of the N pieces of historical content traffic flow consumption time length data is calculated to obtain the content traffic flow consumption time length feature.

According to the resource allocation method provided in some embodiments, the key information and the message verification information are embedded in the traffic flow request packet, and it is determined, by using the message verification information, that the N pieces of historical content traffic flow consumption time length information in a transmitted traffic flow request packet are not tampered with, so that accuracy of data in an information transmission process is improved, and data security in the transmission process is improved.

In an exemplary embodiment of the resource allocation method according to some embodiments corresponding to FIG. 9, reference is made to FIG. 10, S121 further includes S1211 to S1213. S1212 and S1213 are parallel operations. During specific execution, S1212 or S1213 is selected to be performed according to a satisfied condition. The operations are described below specifically.

S1211: Calculate message authentication information of the N pieces of historical content traffic flow consumption time length information based on the key information.

S1212: Determine, if the message authentication information is the same as the message verification information, that the verification succeeds.

S1213: Determine, if the message authentication information is different from the message verification information, that the verification fails.

Verification is performed on the N pieces of historical content traffic flow consumption time length information in the traffic flow request packet based on the key information and the message verification information, to determine that the N pieces of historical content traffic flow consumption time length information are not tampered with in a data transmission process, which is described below specifically.

MAC_his (denoted as MAC_his_cpt_server) is calculated according to formula (3).

If MAC_his_cpt_server=MAC_his, it indicates that the verification succeeds, and the N pieces of historical content traffic flow consumption time length information are not tampered with in a data transmission process. If MAC_his_cpt_server≠MAC_his, it indicates that the verification fails, and the N pieces of historical content traffic flow consumption time length information are tampered with in a data transmission process.

According to the resource allocation method provided in some embodiments, the key information and the message verification information are embedded in the traffic flow request packet, and it is determined, by using the message verification information, that the N pieces of historical content traffic flow consumption time length information in a transmitted traffic flow request packet are not tampered with, so that accuracy of data in an information transmission process is improved, and data security in the transmission process is improved.

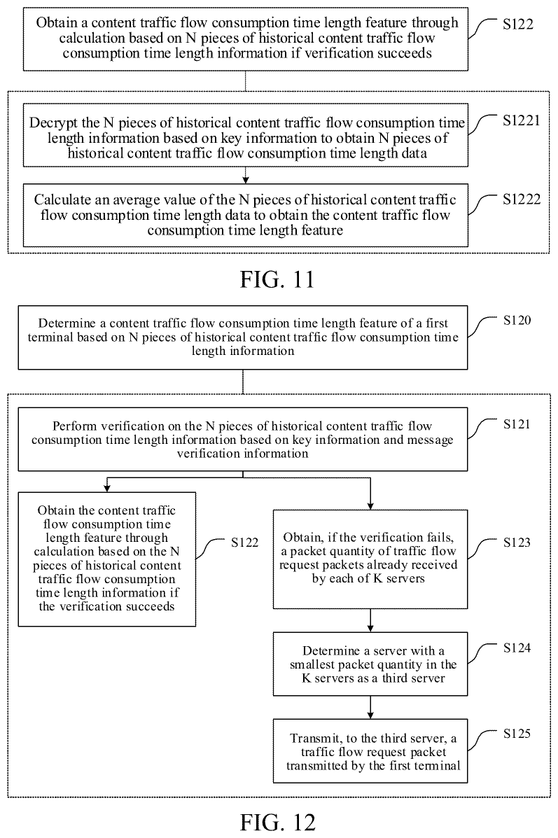

In an exemplary embodiment of the resource allocation method according to some embodiments corresponding to FIG. 9, reference is made to FIG. 11, if the content traffic flow consumption time length feature is a content traffic flow consumption time length average value, S122 includes S1221 and S1222 described below specifically.

S1221: Decrypt the N pieces of historical content traffic flow consumption time length information based on the key information to obtain N pieces of historical content traffic flow consumption time length data.

The load balancer decrypts the N pieces of historical content traffic flow consumption time length information T_session_enc_1, . . . , and T_session_enc_N based on the key information K_share, to obtain the N pieces of historical content traffic flow consumption time length data T_session_1, T_session_2, . . . , and T_session_N. A decryption process is shown in formula (4):

$$T\_session \_i = Dec \{ K\_share , T\_session \_enc \_i \} . \qquad ( 4 )$$

Dec{a, b} indicates that a decryption operation is performed on the data T_session_enc_i by using the key information K_share. Without loss of generality, a smaller parameter i in T_session_i indicates a shorter distance to current time.

S1222: Calculate an average value of the N pieces of historical content traffic flow consumption time length data to obtain the content traffic flow consumption time length feature.

The load balancer calculates an average value T_session_avg of the N pieces of historical content traffic flow consumption time length decrypted data T_session_i, as shown in formula (5):

$$T\_session \_avg = ( T\_session \_ 1 + T\_session \_ 2 + … + T\_session \_N ) / N . \qquad ( 5 )$$

According to the resource allocation method provided in some embodiments, the historical content traffic flow consumption time length information is decrypted by using the key information, an average value of the historical content traffic flow consumption time length decrypted data obtained through decryption is calculated, a behavior habit of the user is determined based on a value size relationship between the average value of the historical content traffic flow consumption time length decrypted data and the historical content traffic flow consumption time length threshold, and further, a server to which a terminal is connected is determined based on the behavior habit of the user, so that continuity and robustness of the server are improved.

In an exemplary embodiment of the resource allocation method according to some embodiments corresponding to FIG. 9, reference is made to FIG. 12, after S121, S123 to S125 are further included. S122 and S123 to S125 are parallel operations. During specific execution, S122 or S123 to S125 are selected to be performed according to an execution condition. The operations are described below specifically.

S123: Obtain, if the verification fails, a packet quantity of traffic flow request packets already received by each of the K servers.

MAC_his (denoted as MAC_his_cpt_server) is calculated according to formula (3).

If MAC_his_cpt_server≠MAC_his, it indicates that the verification fails, and the N pieces of historical content traffic flow consumption time length information are tampered with in a data transmission process. In this case, the N pieces of historical content traffic flow consumption time length information in the traffic flow request packet cannot represent real historical data of the user, for example, a watching habit of the user cannot be accurately predicted by using the N pieces of historical content traffic flow consumption time length information.

S124: Determine a server with a smallest packet quantity in the K servers as a third server.

For the foregoing case, the watching habit of the user is not considered. Instead, a server that is in the K servers and that has a smallest quantity of accessed terminals is selected as the third server through load balancing. A packet quantity of traffic flow request packets already received by each of the K servers is obtained, to determine a quantity of terminals accessing to each server.

S125: Transmit, to the third server, the traffic flow request packet transmitted by the first terminal.

The load balancer forwards, to the third server, the traffic flow request packet transmitted by the first terminal, to connect the first terminal and the third server.

According to the resource allocation method provided in some embodiments, when it is determined that the watching habit of the user cannot be predicted by using the historical content traffic flow consumption time length information, the first terminal accesses to a server with a smallest quantity of accessed terminals, so that continuity and robustness of the server are improved.

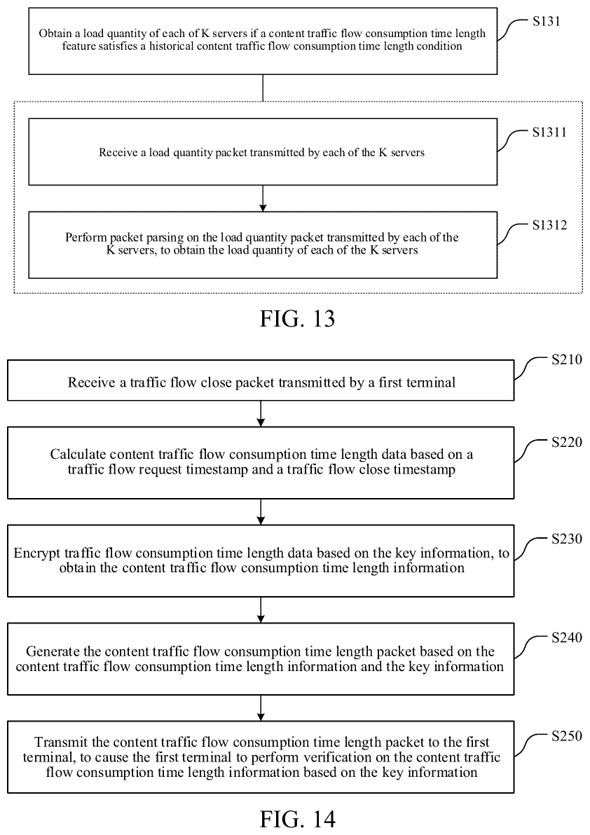

In an exemplary embodiment of the resource allocation method according to some embodiments corresponding to FIG. 4, reference is made to FIG. 13, S131 further includes S1311 to S1312 described below specifically.

S1311: Receive a load quantity packet transmitted by each of the K servers.

Each of the K servers generates a load quantity packet based on a quantity of second terminals that consume long-term traffic flow flows and that currently access to the server, and each of the K servers transmits the generated load quantity packet to the load balancer. The load balancer receives the load quantity packet transmitted by each of the K servers. The load quantity packet may be a packet configured for transmitting the load quantity. The load quantity packet may include a header and a body. The header may be configured for indicating a transmit end and a receive end, and the body may include the load quantity.

S1312: Perform packet parsing on the load quantity packet transmitted by each of the K servers, to obtain the load quantity of each of the K servers.

The load balancer performs packet parsing on the load quantity packet based on the received load quantity packet transmitted by each of the K servers. For example, the load balancer may remove a header of the load quantity packet and extract the load quantity from the body, to obtain the load quantity of each of the K servers.

According to the resource allocation method provided in some embodiments, the load balancer obtains the load quantity of each server based on the received load quantity packet transmitted by each server, to lay a foundation for subsequently determining the first server with a smallest load quantity, so as to distribute terminals with long video traffic flow consumption time lengths across different servers, avoid service interruption caused by excessively high server load due to a plurality of terminals with long video traffic flow consumption time lengths being concentrated in some servers, and improve continuity and robustness of the servers.

In an exemplary embodiment of the resource allocation method according to some embodiments corresponding to FIG. 4, S131 further includes S1313 described below specifically.

S1313: Periodically obtain a load quantity of each of the K servers if the content traffic flow consumption time length feature satisfies the historical content traffic flow consumption time length condition.

Each of the K servers periodically generates a load quantity packet based on the quantity of second terminals that currently access to the server and that consume long-term traffic flows, and each of the K servers transmits the generated load quantity packet to the load balancer. The load balancer periodically receives the load quantity packet transmitted by each of the K servers, and performs packet parsing on the load quantity packet, to obtain the load quantity of each of the K servers.

According to the resource allocation method provided in some embodiments, the load balancer obtains the load quantity of each server based on the received load quantity packet transmitted by each server, to lay a foundation for subsequently determining the first server with a smallest load quantity, so as to distribute terminals with long video traffic flow consumption time lengths across different servers, avoid service interruption caused by excessively high server load due to a plurality of terminals with long video traffic flow consumption time lengths being concentrated in some servers, and improve continuity and robustness of the servers.

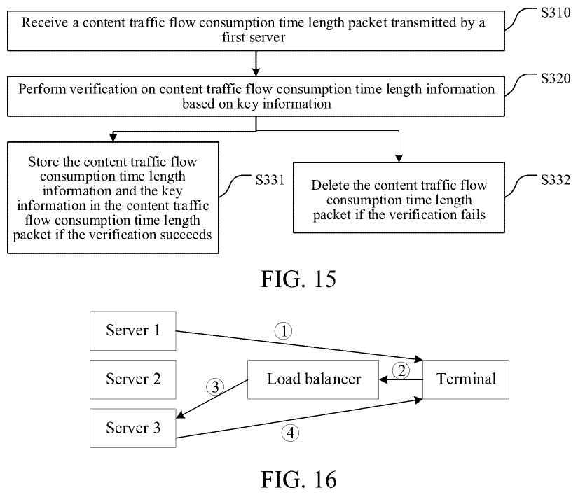

In an exemplary embodiment of the resource allocation method provided in some embodiments corresponding to FIG. 4, the traffic flow request packet includes a traffic flow request timestamp, and the traffic flow request timestamp may be a timestamp at which the traffic flow request packet is transmitted to request to play back content. The load balancer forwards, to the first server, the traffic flow request packet transmitted by the first terminal, to connect the first terminal and the first server. The first server receives the traffic flow request packet carrying the traffic flow request timestamp. After the traffic flow request packet transmitted by the first terminal is transmitted to the first server, reference is made to FIG. 14 and FIG. 15, the resource allocation method further includes S210 to S250 and S310 to S332. S210 to S250 are performed by the first server, and S310 to S332 are performed by the first terminal, which are described below specifically.

S210: Receive a traffic flow close packet transmitted by the first terminal.

The traffic flow close packet carries a traffic flow close timestamp.

When the user ends video watching, an audio/video application is exited. The traffic flow close timestamp may be a time point at which playback of content is stopped. The first terminal may transmit the traffic flow close packet carrying the traffic flow close timestamp to the first server.

S220: Calculate content traffic flow consumption time length data based on the traffic flow request timestamp and the traffic flow close timestamp.

The first server may perform time length calculation based on the traffic flow request timestamp carried in the traffic flow request packet and the traffic flow close timestamp carried in the traffic flow close packet, to obtain the content traffic flow consumption time length data. The content traffic flow consumption time length data may be a specific value of a traffic flow consumption time length for playing back the content. For example, the traffic flow close timestamp may be subtracted from the traffic flow request timestamp to obtain the content traffic flow consumption time length data.

S230: Encrypt the traffic flow consumption time length data based on the key information, to obtain content traffic flow consumption time length information.

The first server obtains the key information, and encrypts the traffic flow consumption time length data based on the key information according to formula (6), to obtain the content traffic flow consumption time length information. The content traffic flow consumption time length information may be information configured for reflecting a time length of traffic flow consumed for playing back the content.

$$T\_session \_enc = Enc \{ K\_share , T\_session \} . \qquad ( 6 )$$

T_session_enc is content traffic flow consumption time length information. K_share is key information. T_session is traffic flow consumption time length data. Enc{a, b} represents performing encryption calculation on b by using a key a.

S240: Generate a content traffic flow consumption time length packet based on the content traffic flow consumption time length information and the key information.

The first server embeds the content traffic flow consumption time length information and the key information in the content traffic flow consumption time length packet, to cause the content traffic flow consumption time length packet to carry the content traffic flow consumption time length information and the key information.

S250: Transmit the content traffic flow consumption time length packet to the first terminal, to cause the first terminal to perform verification on the content traffic flow consumption time length information based on the key information.

The content traffic flow consumption time length information and the key information in the content traffic flow consumption time length packet are stored if the verification succeeds. The content traffic flow consumption time length packet is deleted if the verification fails.

S310: Receive the content traffic flow consumption time length packet transmitted by the first server.

The content traffic flow consumption time length packet carries historical content traffic flow consumption time length information and the key information.

S320: Perform verification on the content traffic flow consumption time length information based on the key information.

S331: Store the content traffic flow consumption time length information and the key information in the content traffic flow consumption time length packet if the verification succeeds.

S332: Delete the content traffic flow consumption time length packet if the verification fails.

The first server transmits the content traffic flow consumption time length packet to the first terminal. The first terminal performs verification on the content traffic flow consumption time length information based on the key information. The first terminal stores the content traffic flow consumption time length information and the key information in the content traffic flow consumption time length packet if the verification succeeds, or the first terminal deletes the content traffic flow consumption time length packet if the verification fails.

According to the resource allocation method provided in some embodiments, the server calculates the content traffic flow consumption time length data, encrypts calculated content traffic flow consumption time length data, then generates the content traffic flow consumption time length packet, and transmits the content traffic flow consumption time length packet to the first terminal. After receiving the content traffic flow consumption time length packet, the first terminal performs verification on the content traffic flow consumption time length information, and if it is determined that the video traffic flow consumption time length information is not tampered with, the first terminal stores the video traffic flow consumption time length information and the key information in the content traffic flow consumption time length packet that are used as information for generating a traffic flow request packet at next time, thereby improving security of data transmission, and laying a foundation for distributing terminals with long content traffic flow consumption time lengths across different servers.

For ease of understanding, FIG. 16 is a flowchart of a resource allocation method according to some embodiments. A process corresponding to an arrow \textcircled{1} is: When a session is ended, a server transmits data (for example, content traffic flow consumption time length data) such as a time length of the session to a terminal (for example, the foregoing first terminal) as historical information (for example, historical content traffic flow consumption time length information) of a user. A process corresponding to an arrow \textcircled{2} is: When the terminal transmits a traffic flow request packet again, the foregoing historical information from the server is carried. A process corresponding to an arrow \textcircled{3} is: When receiving the traffic flow request packet, a load balancer extracts the foregoing historical information and determines whether the user is inclined to watch content for a long period of time or frequently switch watching content. A process corresponding to an arrow \textcircled{4} is: If the user is inclined to watch content for a long period of time, the load balancer selects, for the session, a server that stores content consuming a small long-term traffic flow, and uses the server as a response server. If the user is inclined to frequently switch watching content, the load balancer selects, for the session, a server that stores content with higher smoothness, and uses the server as a response server (for example, the foregoing first server). The selected (or allocated) server transmits traffic flow data to the terminal, and transmits historical information such as the session time length mentioned in \textcircled{1} to the terminal when the session is ended.

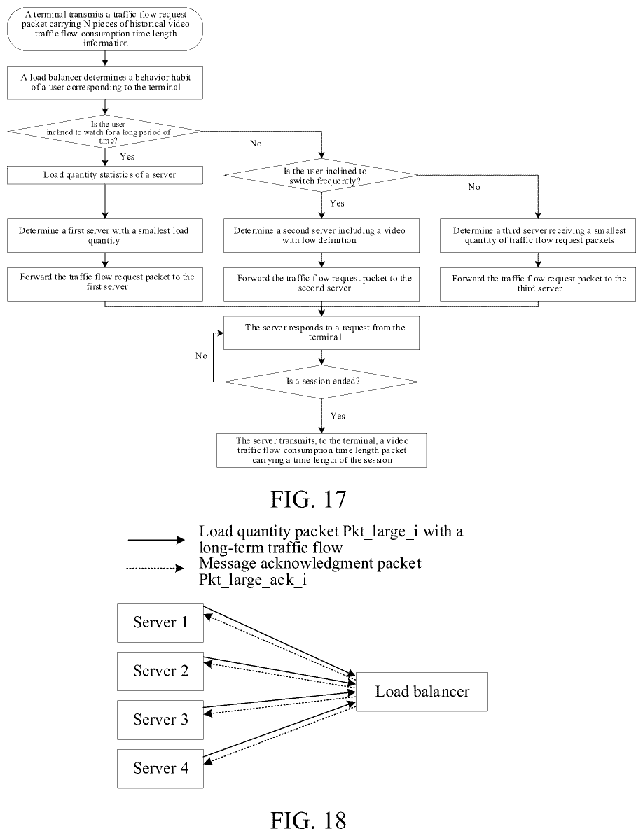

FIG. 17 is a flowchart of a resource allocation method according to some embodiments. According to the method provided in some embodiments, the load balancer allocates a corresponding server for a session based on a historical behavior habit of a user. Specifically, if the user is inclined to watch audio/video content for a long period of time, a server that stores content consuming a small long-term traffic flow is allocated to the user to provide a service for the user, so that excessively high load of a server for a long period of time caused by a plurality of long-term traffic flows clustering on a (or some) server(s) is avoided. If the user is inclined to frequently switch watched audio/video content, a server that stores content with high smoothness is allocated to the user to provide a service for the user, so that deterioration of QoE, such as frame freezing caused by the terminal in a frequent switching process is avoided.

The method provided in some embodiments is described in detail below from four perspectives.

1. When a session between the server and the terminal is ended, the server transmits, to the terminal in an encryption manner, information including such as video traffic flow consumption time length data of latest N sessions of the terminal. Details are as follows.

1.1 A flag indicating that the session between the server and the terminal is ended is: the terminal transmits a traffic flow close packet (close (connection close) packet) to the server, or a user terminal fails to respond to (or feeds back or acknowledges) a traffic flow request packet from the server for a long period of time. One session means that a traffic flow request packet is transmitted.

1.2 When the session is ended, the server calculates current video traffic flow consumption time length data T_session, and encrypts the video traffic flow consumption time length data T_session by using key information K_share shared between the server and the terminal, to obtain video traffic flow consumption time length information T_session_enc, as shown in the following formula (1.1):

$$T\_session \_Enc = Enc \{ K\_share , T\_session \} . \qquad ( 1.1 )$$

Enc{a, b} indicates that encryption calculation is performed on b by using a key a.

1.3 If a plurality of pieces of video traffic flow consumption time length data T_session of the terminal (before a period of time) are included, the plurality of pieces of video traffic flow consumption time length data T_session are encrypted by using the foregoing formula (1.1), to obtain a plurality of pieces of video traffic flow consumption time length information T_session_enc.

1.4 In some embodiments, a time length of the latest N sessions includes N pieces of video traffic flow consumption time length data T_session, respectively denoted as T_session_1, T_session_2, . . . , and T_session_N. Video traffic flow consumption time length information T_session_enc_1, T_session_enc 2, . . . , and T_session_enc_N is obtained through encryption by using the foregoing formula.

1.5 When the session is ended, the server transmits, to the terminal, a video traffic flow consumption time length packet Pkt_history embedded with historical information such as video traffic flow consumption time length information. Data included in the video traffic flow consumption time length packet is as shown in formula (1.2):

$$Pkt\_history = \{ MAC\_his , N , T\_session \_enc \_ 1 , … , T\_session \_enc \_N \} . \qquad ( 1.2 )$$

MAC_his is message verification information of the packet Pkt_history, and may be obtained through calculation by using the following formula (1.3):

$$( 1.3 )$$

$$MAC\_his = MAC \{ K\_share , N ‖ T\_session \_enc \_ 1 ‖ … ‖ T\_session \_enc \_N ) .$$

MAC{A, B} indicates that message verification information of data B is calculated by using a key A.

1.6 In some embodiments, the server does not store historical video traffic flow consumption time length information of each terminal, to avoid large storage overheads and query overheads. The historical video traffic flow consumption time length information of the terminal is stored in the terminal. When the terminal transmits a traffic flow request packet, the traffic flow request packet carries the historical video traffic flow consumption time length information of the terminal.

1.7 In some embodiments, when the session is ended, and the video traffic flow consumption time length packet Pkt_history is received, the terminal reads the message verification information MAC_his, and recalculates MAC_his_cpt according to the foregoing formula (1.3). If MAC_his_cpt=MAC_his, the message verification information MAC_his, N, and the N pieces of video traffic flow consumption time length information T_session_enc are stored locally; otherwise, the video traffic flow consumption time length packet Pkt_history is discarded.

1.8 In some embodiments, a value of the quantity N of the latest sessions may be set by an administrator and embodied in a configuration file, and a default value is 10.

2. When transmitting a traffic flow request packet Pkt_req to the server next time, the terminal also transmits, to the server, the message verification information MAC_his, N, and the N pieces of video traffic flow consumption time length information T_session_enc that are previously received and that are locally stored in the terminal. Details are as follows.

2.1 In some embodiments, the foregoing message verification information MAC_his, N, and N pieces of video traffic flow consumption time length information T_session_enc may be embedded in the traffic flow request packet Pkt_req, or may be transmitted to the server by using a separate packet Pkt_ctl.

2.2 In operation 1.1 to operation 1.6, the server does not store time lengths of the N sessions, but obtains, by using the traffic flow request packet Pkt_req or Pkt_ctl that includes the message verification information MAC_his, N, and N pieces of video traffic flow consumption time length information T_session_enc, video traffic flow consumption time length data of the latest N sessions of the user terminal.

3. After receiving a connection request from the terminal, a load balancer of a CDN cluster extracts the message verification information MAC_his, N, and N pieces of video traffic flow consumption time length information T_session_enc that are carried in the foregoing traffic flow request packet Pkt_req or Pkt_ctl, and determines a historical behavior habit of the terminal based on these pieces of information. Details are as follows.

3.1 The load balancer calculates message authentication information MAC_his_cpt_server according to formula (1.3).

3.2 If the message authentication information is the same as the message verification information, for example, MAC_his_cpt_server=MAC_his, the following operation 3.3 is performed; otherwise, the historical behavior habit of the user is not considered.

3.3 The load balancer decrypts the historical video traffic flow consumption time length information T_session_enc_1, . . . , and T_session_enc_N by using the key information K_share, to obtain latest N times of historical video traffic flow consumption time length data T_session_1, T_session_2, . . . , and T_session_N, and a decryption process is shown in the following formula:

$$T\_session \_i = Dec \{ K\_share , T\_session \_enc \_i \} . \qquad ( 1.4 )$$

Dec{a, b} indicates that a decryption operation is performed on data b by using the key information K_share.

Without loss of generality, a smaller parameter i in T_session_i indicates a shorter distance to current time.

3.4 The load balancer determines a historical behavior habit of the user of the terminal based on decrypted historical video traffic flow consumption time length data T_session_i. Details are as follows.

3.4.1 The load balancer calculates an average value T_session_avg of the N pieces of historical video traffic flow consumption time length data T_session_i, as shown in the following formula:

$$T\_session \_avg = ( T\_session \_ 1 + T\_session \_ 2 + … + T\_session \_N ) / N . \qquad ( 1.5 )$$

If the historical video traffic flow consumption time length average value T_session_avg is greater than a historical video traffic flow consumption time length threshold T_session_upper, it indicates that the user of the terminal is inclined to watch a (or some) piece(s) of content for a long period of time, for example, duration of the session between the server and the user of the terminal may be long. In this case, the following operation 3.4.2 is performed. If the historical video traffic flow consumption time length average value T_session_avg is less than or equal to a historical video traffic flow consumption time length threshold T_session_upper, it indicates that the user of the terminal is inclined to frequently switch watched content, for example, duration of the session between the server and the terminal may be short. In this case, the user of the terminal pays more attention to audio/video smoothness. Specifically, operation 3.4.3 is as follows.

3.4.2 If a user of a newly connected terminal is inclined to watch a piece (or some pieces) of audio/video content for a long period of time, the load balancer sorts the servers in the CDN cluster according to quantities of included long-term traffic flows (for example, a traffic flow of which a traffic flow consumption time length exceeds a first traffic flow time length threshold T_session_upper), and allocates (forwards) a newly obtained connection request to a server with a smallest quantity of long-term traffic flows. To implement the foregoing functions, the load balancer periodically obtains a load quantity of the long-term traffic flows currently included in each server in the CDN cluster. Details are as follows.

3.4.2.1 K servers in the CDN cluster determine magnitudes of traffic flows of the K servers. The magnitude of the traffic flow is determined based on duration of a flow. When the traffic flow consumption time length exceeds the first traffic flow time length threshold T_session_upper, it may be considered that the traffic flow is a long-term traffic flow.

3.4.2.2 Table 1 shows statistics of each server in the CDN cluster. A flow identifier Flow_ID_i is a unique identifier of a flow (session). The server calculates duration of the session based on a difference between current time and session start time.

TABLE 1

| Flow identifier | Start time | Duration |
|---|---|---|
| Flow_ID_1 | Time_start_1 | T_session_1 |
| . . . | . . . | . . . |
| Flow_ID_n | Time_start_n | T_session_n |

3.4.2.3 Each server Server_i in the CDN cluster periodically transmits, to the load balancer, a load quantity packet Pkt_large_i including a long-term traffic flow of the server Server_i. After receiving the load quantity packet Pkt_large_i, the load balancer transmits a message acknowledgment packet Pkt_large_ack_i to the corresponding server Server_i, as shown in FIG. 18.

3.4.3 If a user of a newly connected terminal is inclined to frequently switch watched audio/video content, the load balancer selects a server providing a service for the terminal user from servers in the CDN cluster that have high audio/video smoothness. Details are as follows.

3.4.3.1 In some embodiments, “smoothness” is reflected by audio/video definition. Higher definition indicates lower smoothness, and lower definition indicates higher smoothness.

3.4.3.2 In a CDN server cluster, the same server may store a video with different definition, and the video with different definition is usually stored in two manners: First, after a video is encoded by an encoder, a video with high definition and a video with low definition in the same server are stored. Second, after a video is encoded by an encoder, a video with high definition and a video with low definition are respectively stored in different servers.

3.4.3.3 If the load balancer detects that a behavior habit of a user is to frequently switch watching content (to be specific, T_session_avg is less than a threshold T_session_lower), the load balancer selects the video with low definition (for example, smoothness) to respond to the traffic flow request packet.

When the video with high definition and low definition is stored in the same server (as shown in FIG. 5), the load balancer forwards a connection request from the terminal to the server. The load balancer adds a content definition identifier Mark to the foregoing traffic flow request packet. The identifier occupies 1 bit, and when a value is binary 1, it indicates that a smooth (low-definition) video is transmitted to the terminal.

When the video with high definition and the video with low definition is stored in different servers, the load balancer forwards the traffic flow request packet from the terminal to the server storing the video with low definition.

3.4.3.4 The server in the CDN cluster periodically feeds back the video stored in the server and the definition of the video to the load balancer, so that the load balancer searches for a low-definition video with respect to a request from the terminal for frequently switching audio/video content.

4. When receiving the traffic flow request packet forwarded by the load balancer, the server checks whether a Mark identifier exists in the traffic flow request packet. If the Mark identifier exists and a value of the Mark identifier is binary 1, the server transmits a video with low definition to the terminal; otherwise, the server responds to a request of interrupting the user in a normal traffic flow transmission manner.

According to the method provided in some embodiments, a corresponding server is allocated to a session based on the historical behavior habit of the user. Specifically, if the terminal user is inclined to watch audio/video content for a long period of time, a server that stores content consuming a small long-term traffic flow is allocated to the user to provide a service for the terminal user, so that excessively high load of a server for a long period of time caused by a plurality of long-term traffic flows clustering on a (or some) server(s) is avoided. If the terminal user is inclined to frequently switch watched audio/video content, a server that stores content with high smoothness is allocated to the user to provide a service for the user, so that deterioration of QoE, such as frame freezing caused by the user terminal in a frequent switching process is avoided. According to some embodiments, a load balancing operation is performed based on the historical behavior habit of the user, so that excessively high load caused by a plurality of long-term traffic flows clustering on a (or some) server(s) is avoided. In addition, for a habit that users who frequently switch audio/video resources do not pay much attention to audio/video definition, an audio/video resource with high smoothness may be selected for the users. When costs are limited, service experience of a client can be greatly improved, so that improvement of continuity and robustness of a service capability of a CDN manufacturer is facilitated.

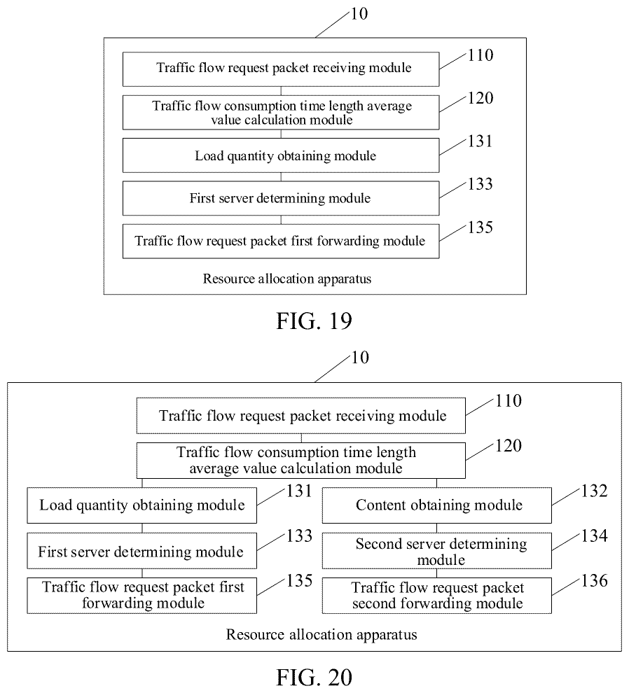

The following describes a resource allocation apparatus in detail. FIG. 19 is a schematic diagram of some embodiments of the resource allocation apparatus 10 according to some embodiments. The resource allocation apparatus 10 includes:
a traffic flow request packet receiving module 110, configured to receive a traffic flow request packet transmitted by a first terminal, the traffic flow request packet carrying N pieces of historical content traffic flow consumption time length information, and N being an integer greater than 1;
a traffic flow consumption time length average value calculation module 120, configured to determine a content traffic flow consumption time length feature of the first terminal based on the N pieces of historical content traffic flow consumption time length information;
a load quantity obtaining module 131, configured to obtain a load quantity of each of K servers if the content traffic flow consumption time length feature satisfies a historical content traffic flow consumption time length condition,
the load quantity of the server being a quantity of second terminals accessing to the server, the second terminal is a terminal of which a traffic flow consumption time length accessed by the server is greater than a first traffic flow time length threshold, and K is an integer greater than 1;
a first server determining module 133, configured to determine a server with a smallest load quantity in the K servers as a first server; and
a traffic flow request packet first forwarding module 135, configured to transmit, to the first server, the traffic flow request packet transmitted by the first terminal.

Some embodiments provides a resource allocation apparatus. The content traffic flow consumption time length feature corresponding to the N pieces of historical content traffic flow consumption time length information of the first terminal is compared with the historical content traffic flow consumption time length condition. If the content traffic flow consumption time length feature satisfies the historical content traffic flow consumption time length condition, a server with a smallest load quantity in the K servers is determined as the first server, and the traffic flow request packet of the first terminal is transmitted to the first server, to connect the first terminal and the first server. According to the apparatus provided in some embodiments, terminals with long content traffic flow consumption time lengths are distributed across different servers, to avoid service interruption caused by excessively high server load due to a plurality of terminals with long content traffic flow consumption time lengths being concentrated in some servers, and improve continuity and robustness of the servers.

In an exemplary embodiment of the resource allocation apparatus provided in some embodiments corresponding to FIG. 19, reference is made to FIG. 20, the traffic flow request packet further carries content identifier information. The resource allocation apparatus further includes:
a content obtaining module 132, configured to obtain content stored in each of the K servers and definition of the content if the content traffic flow consumption time length feature does not satisfy the historical content traffic flow consumption time length condition;
a second server determining module 134, configured to determine a second server from the K servers based on the content identifier information, where
the second server is a server storing content that is the same as to-be-processed content indicated by the content identifier information and of which definition is lower than a definition threshold; and
a traffic flow request packet second forwarding module 136, configured to transmit, to the second server, the traffic flow request packet transmitted by the first terminal.

Some embodiments provides a resource allocation apparatus. The content traffic flow consumption time length feature corresponding to the N pieces of historical content traffic flow consumption time length information of the terminal is compared with the historical content traffic flow consumption time length condition. If the content traffic flow consumption time length feature satisfies the historical content traffic flow consumption time length condition, the first server with a smallest load quantity in K servers is determined, and the traffic flow request packet of the first terminal is transmitted to the first server, to connect the first terminal and the first server. If the content traffic flow consumption time length feature does not satisfy the historical content traffic flow consumption time length condition, it is determined that a second server in the K servers stores to-be-processed content with low definition, and the traffic flow request packet of the first terminal is transmitted to the second server, to connect the first terminal and the second server. According to the apparatus provided in some embodiments, terminals with long content traffic flow consumption time lengths are distributed across different servers, to avoid service interruption caused by excessively high server load due to a plurality of terminals with long content traffic flow consumption time lengths being concentrated in some servers. A server storing a video with low definition and high smoothness is selected for a user who frequently switches content, so that frame freezing caused by the user in a process of frequently switching videos is avoided. The server to which the terminal is connected is determined based on a behavior habit of the user, so that continuity and robustness of the server are improved.

In an exemplary embodiment of the resource allocation apparatus according to some embodiments corresponding to FIG. 20, the traffic flow request packet second forwarding module 136 is further configured to:
obtain definition of the to-be-processed content stored in the second server;
add, if the second server stores at least two pieces of to-be-processed content with different definition, a definition mark to the traffic flow request packet, and then transmit a traffic flow request packet carrying the definition mark to the second server, where
the added definition mark is configured for indicating the second server to transmit to-be-processed content of which definition is lower than the definition threshold to the first terminal; and
transmit, to the second server, the traffic flow request packet transmitted by the first terminal if the definition of all the to-be-processed content stored in the second server is lower than the definition threshold.

Some embodiments provides a resource allocation apparatus. A server storing a video with low definition and high smoothness is selected for a user who frequently switches to watch a video, so that frame freezing caused by the user in a process of frequently switching videos is avoided, and continuity and robustness of the server are improved.

In an exemplary embodiment of the resource allocation apparatus according to some embodiments corresponding to FIG. 20, the content obtaining module 132 is further configured to periodically obtain the content stored in each of the K servers and the definition of the content.

According to the resource allocation apparatus provided in some embodiments, a video resource stored in each server and definition of the video resource are periodically obtained, and a server storing a target video with low definition is selected as a second server, so that frame freezing caused by the user in a process of frequently switching videos is avoided.

In an exemplary embodiment, the content traffic flow consumption time length feature is a content traffic flow consumption time length average value, and the historical content traffic flow consumption time length condition is that the content traffic flow consumption time length average value is greater than a historical content traffic flow consumption time length threshold.

In an exemplary embodiment of the resource allocation apparatus according to some embodiments corresponding to FIG. 19, the traffic flow request packet further includes key information and message verification information. The traffic flow consumption time length average value calculation module 120 is further configured to:
perform verification on the N pieces of historical content traffic flow consumption time length information based on the key information and the message verification information; and
obtain the content traffic flow consumption time length feature through calculation based on the N pieces of historical content traffic flow consumption time length information if the verification succeeds.

According to the resource allocation apparatus provided in some embodiments, the key information and the message verification information are embedded in the traffic flow request packet, and it is determined, by using the message verification information, that the N pieces of historical video traffic flow consumption time length information in a transmitted traffic flow request packet are not tampered with, so that accuracy of data in an information transmission process is improved, and data security in the transmission process is improved.

In an exemplary embodiment of the resource allocation apparatus according to some embodiments corresponding to FIG. 19, the traffic flow consumption time length average value calculation module 120 is further configured to:
calculate message authentication information of the N pieces of historical content traffic flow consumption time length information based on the key information; and
determine, if the message authentication information is the same as the message verification information, that the verification succeeds; or
determine, if the message authentication information is different from the message verification information, that the verification fails.

According to the resource allocation apparatus provided in some embodiments, the key information and the message verification information are embedded in the traffic flow request packet, and it is determined, by using the message verification information, that the N pieces of historical video traffic flow consumption time length information in a transmitted traffic flow request packet are not tampered with, so that accuracy of data in an information transmission process is improved, and data security in the transmission process is improved.

In an exemplary embodiment of the resource allocation apparatus according to some embodiments corresponding to FIG. 19, if the content traffic flow consumption time length feature is the content traffic flow consumption time length average value, the traffic flow consumption time length average value calculation module 120 is further configured to:
decrypt the N pieces of historical content traffic flow consumption time length information based on the key information to obtain N pieces of historical content traffic flow consumption time length data; and
calculate an average value of the N pieces of historical content traffic flow consumption time length data to obtain the content traffic flow consumption time length feature.

According to the resource allocation apparatus provided in some embodiments, the historical video traffic flow consumption time length information is decrypted by using the key information, an average value of the historical video traffic flow consumption time length data obtained through decryption is calculated, a behavior habit of the user is determined based on a value size relationship between the average value of the historical video traffic flow consumption time length data and the historical video traffic flow consumption time length threshold, and further, a server to which a terminal is connected is determined based on the behavior habit of the user, so that continuity and robustness of the server are improved.

In an exemplary embodiment of the resource allocation apparatus according to some embodiments corresponding to FIG. 19, the traffic flow consumption time length average value calculation module 120 further includes:
a traffic flow request packet quantity obtaining module 123, configured to: obtain, if the verification fails, a packet quantity of traffic flow request packets already received by each of the K servers;
a third server determining module 124, configured to determine a server with a smallest packet quantity in the K servers as a third server; and
a traffic flow request packet third forwarding module 125, configured to transmit, to the third server, the traffic flow request packet transmitted by the first terminal.

According to the resource allocation apparatus provided in some embodiments, when it is determined that the watching habit of the user cannot be predicted by using the historical video traffic flow consumption time length information, a terminal accesses to a server with a smallest quantity of accessed terminals, so that continuity and robustness of the server are improved.

In an exemplary embodiment of the resource allocation apparatus according to some embodiments corresponding to FIG. 19, the load quantity obtaining module 131 is further configured to:
receive a load quantity packet transmitted by each of the K servers; and
perform packet parsing on the load quantity packet transmitted by each of the K servers, to obtain the load quantity of each of the K servers.

According to the resource allocation apparatus provided in some embodiments, the load balancer obtains a load quantity of each server according to a received load quantity packet transmitted by each server, so as to lay a foundation for subsequently determining a first server having a smallest load quantity, to distribute terminals with long video traffic flow consumption time lengths across different servers, avoid service interruption caused by excessively high server load due to a plurality of terminals with long video traffic flow consumption time lengths being concentrated in some servers, and to improve continuity and robustness of the servers.

In an exemplary embodiment of the resource allocation apparatus according to some embodiments corresponding to FIG. 19, the load quantity obtaining module 131 is further configured to periodically obtain a load quantity of each of the K servers.

According to the resource allocation apparatus provided in some embodiments, the load balancer obtains a load quantity of each server according to a received load quantity packet transmitted by each server, so as to lay a foundation for subsequently determining a first server having a smallest load quantity, to distribute terminals with long video traffic flow consumption time lengths across different servers, avoid service interruption caused by excessively high server load due to a plurality of terminals with long video traffic flow consumption time lengths being concentrated in some servers, and to improve continuity and robustness of the servers.

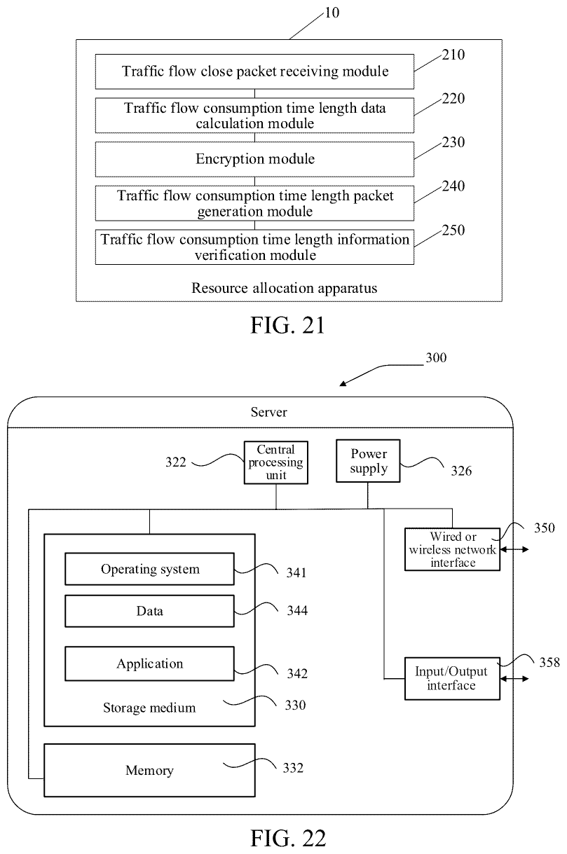

In an exemplary embodiment of the resource allocation apparatus according to some embodiments corresponding to FIG. 19, reference is made to FIG. 21, the traffic flow request packet includes a traffic flow request timestamp. The resource allocation apparatus 10 further includes:
a traffic flow close packet receiving module 210, configured to receive a traffic flow close packet transmitted by the first terminal, where
the traffic flow close packet carries a traffic flow close timestamp;
a traffic flow consumption time length data calculation module 220, configured to calculate content traffic flow consumption time length data based on the traffic flow request timestamp and the traffic flow close timestamp;
an encryption module 230, configured to encrypt the traffic flow consumption time length data based on the key information, to obtain content traffic flow consumption time length information;
a traffic flow consumption time length packet generation module 240, configured to generate a content traffic flow consumption time length packet based on the content traffic flow consumption time length information and the key information; and
a traffic flow consumption time length information verification module 250, configured to transmit the content traffic flow consumption time length packet to the first terminal, to cause the first terminal to perform verification on the content traffic flow consumption time length information based on the key information, where
the content traffic flow consumption time length information and the key information in the content traffic flow consumption time length packet are stored if the verification succeeds; or the content traffic flow consumption time length packet is deleted if the verification fails.

According to the resource allocation apparatus provided in some embodiments, the server calculates the content traffic flow consumption time length data, encrypts calculated data, then generates the content traffic flow consumption time length packet, and transmits the content traffic flow consumption time length packet to the first terminal. After receiving the content traffic flow consumption time length packet, the first terminal performs verification on the content traffic flow consumption time length information, and if it is determined that the content traffic flow consumption time length information is not tampered with, the first terminal stores the content traffic flow consumption time length information and the key information in the content traffic flow consumption time length packet that are used as information for generating a traffic flow request packet at next time, thereby improving security of data transmission, and laying a foundation of distributing terminals with long content traffic flow consumption time lengths across different servers.

FIG. 22 is a schematic diagram of a structure of a server according to some embodiments. The server 300 may vary greatly due to different configurations or performance, and may include one or more central processing units (CPUs) 322 (for example, one or more processors), a memory 332, and one or more storage media 330 (for example, one or more mass storage devices) that store application programs 342 or data 344. The memory 332 and the storage medium 330 may be used for temporary storage or persistent storage. A program stored in the storage medium 330 may include one or more modules (not shown in the figure), and each module may include a series of instruction operations on the server. Further, the central processing unit 322 may be configured to communicate with the storage medium 330 and perform on the server 300 the series of instruction operations in the storage medium 330.

The server 300 may further include one or more power supplies 326, one or more wired or wireless network interfaces 350, one or more input/output interfaces 358, and/or one or more operating systems 341, for example, Windows Server™, Mac OS X™ Unix™, Linux™, and FreeBSD™.

Operations performed by the server in the foregoing embodiment may be based on the server structure shown in FIG. 22.

A person skilled in the art would understand that these “modules” could be implemented by hardware logic, a processor or processors executing computer software code, or a combination of both. The “modules” may also be implemented in software stored in a memory of a computer or a non-transitory computer-readable medium, where the instructions of each module are executable by a processor to thereby cause the processor to perform the respective operations of the corresponding module.

According to some embodiments, each module or unit may exist respectively or be combined into one or more units. Some units may be further split into multiple smaller function subunits, thereby implementing the same operations without affecting the technical effects of some embodiments. The units are divided based on logical functions. In actual applications, a function of one unit may be realized by multiple units, or functions of multiple units may be realized by one unit. In some embodiments, the apparatus may further include other units. These functions may also be realized cooperatively by the other units, and may be realized cooperatively by multiple units.

The foregoing embodiments are used for describing, instead of limiting the technical solutions of the disclosure. A person of ordinary skill in the art shall understand that although the disclosure has been described in detail with reference to the foregoing embodiments, modifications can be made to the technical solutions described in the foregoing embodiments, or equivalent replacements can be made to some technical features in the technical solutions, provided that such modifications or replacements do not cause the essence of corresponding technical solutions to depart from the spirit and scope of the technical solutions of the embodiment of the disclosure and the appended claims.

What is claimed is:

1. A resource allocation method, performed by a computer device, the method comprising:
receiving a traffic flow request packet transmitted by a first terminal, the traffic flow request packet comprising one or more pieces of historical content traffic flow consumption time length information;
determining a content traffic flow consumption time length feature of the first terminal based on the historical content traffic flow consumption time length information;
obtaining a load quantity of one or more servers based on the content traffic flow consumption time length feature meeting a historical content traffic flow consumption time length condition;
wherein the load quantity of each server is determined based on a number of second terminals accessing each server, each second terminal has a content traffic flow consumption time length greater than a first traffic flow time length threshold;
determining a server with a least load quantity among the one or more servers as a first server; and
transmitting the traffic flow request packet to the first server.

2. The resource allocation method according to claim 1,
wherein the traffic flow request packet comprises content identifier information,
the method further comprising:
obtaining stored content and definition of the content in the one or more servers based on the content traffic flow consumption time length feature not meeting the historical content traffic flow consumption time length condition;
determining a second server from the one or more servers based on the content identifier information, wherein the second server stores content that matches to-be-processed content based on the content identifier information and has lower definition than a definition threshold; and
transmitting the traffic flow request packet to the second server.

3. The resource allocation method according to claim 2, further comprising:
obtaining definition information of to-be-processed content stored in the second server;
adding, based on the second server storing at least two pieces of to-be-processed content with different definition, a definition mark to the traffic flow request packet;
transmitting a traffic flow request packet comprising the definition mark to the second server, wherein the definition mark indicates the second server to transmit to-be-processed content that has lower definition than the definition threshold to the first terminal; and
transmitting the traffic flow request packet to the second server based on the definition of all the to-be-processed content lower than the definition threshold.

4. The resource allocation method according to claim 2, further comprising:
periodically obtaining the content stored in the one or more servers and the definition of the content.

5. The resource allocation method according to claim 1,
wherein the content traffic flow consumption time length feature is an average consumption time length value,
wherein the historical content traffic flow consumption time length condition is met based on the average consumption time length value being greater than a historical content traffic flow consumption time length threshold.

6. The resource allocation method according to claim 1,
wherein the traffic flow request packet comprises key information and message verification information,
the method further comprising:
verifying the one or more pieces of historical content traffic flow consumption time length information based on the key information and the message verification information; and
obtaining, based on successful verification, the content traffic flow consumption time length feature with calculation based on the one or more pieces of historical content traffic flow consumption time length information.

7. The resource allocation method according to claim 6, further comprising:
computing message authentication information of the one or more pieces of historical content traffic flow consumption time length information based on the key information; and
determining that verification succeeds based on the message authentication information matching the message verification information, or that verification fails based on the message authentication information not matching the message verification information.

8. The resource allocation method according to claim 6, wherein the content traffic flow consumption time length feature is the average consumption time length value, the method further comprising:
decrypting the one or more pieces of historical content traffic flow consumption time length information based on the key information;
obtaining one or more pieces of historical content traffic flow consumption time length data;
calculating an average value of the one or more pieces of historical content traffic flow consumption time length data; and
obtaining the content traffic flow consumption time length feature.

9. The resource allocation method according to claim 6, further comprising:
obtaining, based on unsuccessful verification, a packet quantity of traffic flow request packets that are already received from the one or more servers;
determining a server with a smallest packet quantity in the one or more servers as a third server; and
transmitting the traffic flow request packet to the third server.

10. The resource allocation method according to claim 1, further comprising:
receiving a load quantity packet from the one or more servers;
parsing the load quantity; and
obtaining the load quantity of one or more servers.

11. The resource allocation method according to claim 1,
wherein the traffic flow request packet comprises a traffic flow request timestamp,
the method further comprising:
receiving a traffic flow close packet from the first terminal, the traffic flow close packet comprising a traffic flow close timestamp;
computing content traffic flow consumption time length data based on the traffic flow request timestamp and the traffic flow close timestamp;
encrypting the content traffic flow consumption time length data based on key information;
obtaining content traffic flow consumption time length information;
generating a content traffic flow consumption time length packet based on the content traffic flow consumption time length information and the key information; and
transmitting the content traffic flow consumption time length packet to the first terminal;
wherein the first terminal:
verifies the content traffic flow consumption time length information based on the key information; and
stores the content traffic flow consumption time length information and the key information in the content traffic flow consumption time length packet based on successful verification, or deletes the content traffic flow consumption time length packet based on unsuccessful verification.

12. The resource allocation method according to claim 1, further comprising:
periodically obtaining the load quantity of the one or more servers.

13. A resource allocation apparatus, comprising:
at least one memory configured to store program code; and
at least one processor configured to read the program code and operate as instructed by the program code, the program code comprising:
receiving code configured to cause at least one of the at least one processor to receive a traffic flow request packet transmitted by a first terminal, the traffic flow request packet comprising one or more pieces of historical content traffic flow consumption time length information;
determining code configured to cause at least one of the at least one processor to determine a content traffic flow consumption time length feature of the first terminal based on the one or more pieces of historical content traffic flow consumption time length information;
obtaining code configured to cause at least one of the at least one processor to obtain a load quantity of one or more servers based on the content traffic flow consumption time length feature meeting a historical content traffic flow consumption time length condition,
wherein the load quantity of each server is determined based on a number of second terminals accessing each server, each second terminal has a content traffic flow consumption time length greater than a first traffic flow time length threshold,
wherein the determining code is further configured to cause at least one of the at least one processor to determine a server with a least load quantity among the one or more servers as a first server; and
transmission code configured to cause at least one of the at least one processor to transmit the traffic flow request packet to the first server.

14. The resource allocation apparatus according to claim 13,
wherein the traffic flow request packet further comprises content identifier information,
wherein the obtaining code is further configured to cause at least one of the at least one processor to obtain stored content and definition of the content in the one or more servers based on the content traffic flow consumption time length feature not meeting the historical content traffic flow consumption time length condition,
wherein the determining code is further configured to cause at least one of the at least one processor to determine a second server from the one or more servers based on the content identifier information,
wherein the second server stores content that matches to-be-processed content based on the content identifier information and has lower definition than a definition threshold, and
wherein the transmission code is further configured to cause at least one of the at least one processor to transmit the traffic flow request packet to the second server.

15. The resource allocation apparatus according to claim 14,
wherein the obtaining code is further configured to cause at least one of the at least one processor to obtain definition of to-be-processed content stored in the second server,
wherein the program code further comprises:
adding code configured to cause at least one of the at least one processor to add, based on the second server storing at least two pieces of to-be-processed content with different definition, a definition mark to the traffic flow request packet,
wherein the transmission code is further configured to cause at least one of the at least one processor to transmit a traffic flow request packet comprising the definition mark to the second server,
wherein the definition mark indicates the second server to transmit to-be-processed content that has lower definition than the definition threshold to the first terminal, and
wherein the transmission code is further configured to cause at least one of the at least one processor to transmit the traffic flow request packet to the second server based on the definition of all the to-be-processed content lower than the definition threshold.

16. The resource allocation apparatus according to claim 14,
wherein the obtaining code is further configured to cause at least one of the at least one processor to periodically obtain the stored content and definition of the content in the one or more servers.

17. The resource allocation apparatus according to claim 13,
wherein the content traffic flow consumption time length feature comprises an average consumption time length value, and
wherein the historical content traffic flow consumption time length condition is met based on the average consumption time length value being greater than a historical consumption time length threshold.

18. The resource allocation apparatus according to claim 13,
wherein the traffic flow request packet further comprises key information and verification information, and
wherein the program code further comprises:
verification code configured to cause at least one of the at least one processor to verify the one or more pieces of historical content traffic flow consumption time length information based on the key information and the verification information,
wherein the determining code is further configured to cause at least one of the at least one processor to determine the content traffic flow consumption time length feature based on the one or more pieces of historical content traffic flow consumption time length information and based on successful verification.

19. The resource allocation apparatus according to claim 18,
wherein the program code further comprises:
computation code configured to cause at least one of the at least one processor to compute authentication information of the one or more pieces of historical content traffic flow consumption time length information based on the key information;
wherein the determining code is further configured to cause at least one of the at least one processor to:
determine that the verification succeeds based on the message authentication information matching the message verification information, or that the verification fails based on the message authentication information not matching the message verification information.

20. A non-transitory computer-readable storage medium storing computer code which, when executed by at least one processor, causes the at least one processor to at least:
receive a traffic flow request packet transmitted by a first terminal, the traffic flow request packet comprising one or more pieces of historical content traffic flow consumption time length information;
determine a content traffic flow consumption time length feature of the first terminal based on the one or more pieces of historical content traffic flow consumption time length information;
obtaining a load quantity of one or more servers based on the content traffic flow consumption time length feature meeting a historical content traffic flow consumption time length condition,
wherein the load quantity of each server is determined based on a number of second terminals accessing each server, each second terminal has a content traffic flow consumption time length greater than a first traffic flow time length threshold;
determine a server with a least load quantity among the one or more servers as a first server; and
transmit the traffic flow request packet to the first server.
